(19) United States
(12) Patent Application Publication
(10) Pub. No.: US 2026/0236909 A1
(43) Pub. Date: Aug. 13, 2026

(54) SYSTEMS AND METHODS FOR SHARING A CANDIDATE DATASET AT A PROVIDER NODE

(71) Applicant: Privara Inc., Westmount (CA)

(72) Inventor: Corbin CHURCH, Westmount (CA)

(73) Assignee: Privara Inc., Westmount (CA)

(21) Appl. No.: 19/530,489

(22) Filed: Feb. 5, 2026

Related U.S. Application Data
(60) Provisional application No. 63/756,777, filed on Feb. 10, 2025.

(51) Int. Cl. G06Q 20/36

(52) U.S. Cl. CPC G06Q 20/367

(57) ABSTRACT

Provided are methods and systems for sharing a candidate dataset at a data provider node, comprising: receiving the candidate dataset and metadata associated with the candidate dataset; sending, to an off-chain storage node, the dataset; generating a listing identifier and an integrity reference linking the metadata to the dataset in the off-chain storage node; sending a dataset listing request; and receiving based on the dataset listing request, a dataset listing response comprising a confirmation from the platform node that the dataset has been registered and stored, wherein when the processor receives a recorded purchase state associated with the listing identifier from a smart contract, emitting to a buyer wallet address an access-key payload comprising the access identifier that is usable by a consumer node associated with the buyer wallet address to access the dataset at the off-chain storage node.

### CROSS REFERENCE TO RELATED APPLICATION

This application claims the benefit of U.S. provisional patent application No. 63/756,777 filed Feb. 10, 2025, the entire contents of which are hereby incorporate by reference.

### TECHNICAL FIELD

The present disclosure pertains to privacy-preserving data exchange systems, specifically to decentralized platforms for secure sharing, scoring, and transaction of encrypted datasets using blockchain-based escrow and metadata-driven mechanisms.

### BACKGROUND OF THE ART

The problem domain addressed by the present disclosure lies in the secure and privacy-preserving exchange of industrial datasets, particularly within decentralized marketplaces. Existing systems for data sharing and monetization face significant limitations in balancing privacy, scalability, and usability. Conventional approaches often rely on centralized repositories or bilateral agreements, which introduce single points of failure, trust dependencies, and heightened risks of exposing sensitive industrial data. Furthermore, these systems lack robust mechanisms for anonymization, metadata-driven quality evaluation, and conditional access enforcement, making them unsuitable for industries where proprietary processes and competitive intelligence need to remain confidential. Efforts to integrate blockchain technology have partially addressed transparency and immutability but have struggled to manage large off-chain datasets, enforce licensing tiers, and provide dynamic quality scoring without compromising privacy or efficiency.

The field of privacy-preserving data exchange has grown in response to the increasing importance of sensitive industrial information and the need for controlled distribution across organizational boundaries. In industrial automation environments, datasets often comprise sensor data from machinery such as pumps, compressors, or automotive assembly lines. Sharing such datasets can enable benchmarking, predictive maintenance, and cross-industry research, but also raises concerns about revealing the identity of the data source, which may expose proprietary processes, operational strategies, or competitive intelligence.

A further driver for sharing industrial datasets is the advancement of machine learning and artificial intelligence applications. The development and training of robust machine learning models for predictive maintenance, anomaly detection, and process optimization require access to large, diverse, and high-quality datasets. However, organizations are often reluctant to share their operational data due to the risk of source identification and the potential exposure of competitive information. This reluctance creates a technical barrier to the creation of effective machine learning models, as the lack of accessible, anonymized datasets limits the ability of researchers and solution providers to develop, validate, and generalize advanced algorithms for industrial automation.

Traditional data marketplaces and sharing platforms often rely on centralized repositories or direct bilateral arrangements, creating single points of control and potential exposure of confidential industrial data. Recent trends have explored decentralized approaches that separate metadata registration and transaction settlement from the actual storage of encrypted payloads. These approaches leverage distributed ledger technology to record immutable references and enforce access conditions, while off-chain storage retains the bulk of the data under cryptographic protections. As industrial actors seek robust methods to share, evaluate, and monetize datasets without revealing proprietary details or the identity of the data source, the convergence of blockchain-based escrow, metadata-driven mechanisms, tokenized payments and anonymous, secure, sharing and access-control becomes increasingly significant.

Industrial enterprises require platforms that not only protect raw sensor data but also facilitate discovery, valuation, and fair compensation in a privacy-compliant manner. Effective solutions enable data providers to submit standardized descriptors and quality indicators, allowing consumers to evaluate suitability prior to purchase. Such platforms are designed to address regulatory and competitive concerns by supporting anonymous or pseudonymous credentials and attested identities, ensuring that the source of the dataset remains confidential. Additionally, automated pricing guidance, secure and tokenized micropayment channels, and transparent fee structures contribute to balancing provider incentives with consumer budgets. Streamlined user experiences for dataset upload, search, purchase, and delivery play a significant role in encouraging adoption in industrial and research-oriented environments.

Despite these advances, existing systems often face significant hurdles in combining strong privacy guarantees with practical transaction workflows. Centralized escrow mechanisms can introduce trust dependencies and single-party failures, while purely on-chain storage of large datasets is impractical due to cost and performance constraints. Efforts to link off-chain encrypted payloads with on-chain metadata frequently rely on manual verification steps, leading to inefficiencies and potential integrity gaps. Quality evaluation is typically limited to basic metadata completeness checks or ad hoc reputation scores, lacking a unified, objective framework that can be automatically computed and compared across diverse dataset types. Furthermore, most platforms offer only rudimentary dispute-resolution processes, with constrained windows for challenge and limited support for tiered licensing or time-bound access.

A more nuanced shortcoming arises from the absence of cohesive methods to enforce conditional release of encrypted industrial datasets based on on-chain events, while simultaneously integrating metadata-driven quality scoring and policy enforcement. In particular, systems struggle to manage multi-stage escrow workflows that protect both buyers and sellers, maintain anonymity of the data source, and provide data integrity without revealing raw content. There is also a gap in providing dynamic quality signals derived solely from metadata and structural characteristics, which can inform discovery ranking and pricing recommendations. Additionally, license tier enforcement and periodic access rotations remain manual or simplistic, hindering flexible usage models such as subscription-based streaming or transient data feeds. These limitations underscore the need for a holistic platform that unifies decentralized escrow, metadata-centric scoring, and secure off-chain delivery into an elegant, privacy-preserving marketplace framework for industrial automation datasets-thereby enabling the secure and scalable sharing of data necessary for the advancement of machine learning and artificial intelligence in industrial domains.

### SUMMARY

The concept disclosed herein enhances previous approaches by presenting a unified platform that incorporates decentralized escrow mechanisms, metadata-focused scoring systems, tokenized payments and secure off-chain storage to facilitate privacy-preserving dataset transactions. The disclosed system utilizes blockchain-based smart contracts to record transaction states, enforce escrow conditions, and establish governance policies, while ensuring that raw datasets remain off-chain and inaccessible to the blockchain layer. A specialized scoring engine assesses dataset quality based on metadata completeness, structural characteristics, timestamp density, and anonymization reliability, generating standardized quality signals that support discovery ranking and pricing guidance. This scoring process is conducted transiently and does not retain raw dataset payloads, maintaining privacy while enabling objective evaluation.

Additionally, the described system incorporates zero-knowledge proof (ZKP)-based compliance verification, allowing participants to pass KYC/KYB checks without revealing their legal identities. Anonymous buyer-seller communication channels and dispute resolution workflows further enhance privacy and usability. The system architecture supports dynamic licensing enforcement, time-limited access credentials, and streaming dataset models, enabling flexible usage scenarios such as subscription-based access or transient data feeds. By combining these elements, the described framework provides a scalable, privacy-compliant solution for industrial data exchange, addressing the technical barriers that have historically hindered collaboration and progress in machine learning and industrial automation domains.

In a first aspect, there is provided a computer-implemented method for sharing a candidate dataset at a data provider node, comprising: receiving, at a processor of the data provider node, the candidate dataset and metadata associated with the candidate dataset; sending, from the processor to an off-chain storage node, the dataset; generating, at the processor, a listing identifier and an integrity reference linking the metadata to the dataset in the off-chain storage node; sending, from the processor to a platform node, a dataset listing request comprising the listing identifier, the metadata and the integrity reference linking the metadata to the dataset in the off-chain storage node; and receiving, at the processor based on the dataset listing request, a dataset listing response comprising a confirmation from the platform node that the dataset has been registered and stored, wherein when the processor receives a recorded purchase state associated with the listing identifier from a smart contract, emitting to a buyer wallet address an access-key payload comprising the access identifier that is usable by a consumer node associated with the buyer wallet address to access the dataset at the off-chain storage node.

In one or more embodiments, the method may further comprise: receiving, at the processor, a smart contract completion indication comprising a buyer identifier; and transmitting, based on the smart contract completion indication, the access key for the off-chain storage to a data consumer node identified by the buyer identifier.

In one or more embodiments, the dataset listing request may further comprise the metadata, the integrity reference to the location of the dataset at the off-chain storage node, wherein the metadata used by the platform node to generate a dataset quality score for comparative ranking and pricing of the dataset without revealing an identity of the data provider node, the data consumer node, and the platform node.

In one or more embodiments, the method may further comprise: determining, at the processor, classification metadata for the candidate dataset; determining, at the processor, coverage metadata for the candidate dataset; determining, at the processor, timestamp density metadata of the candidate dataset; and determining, at the processor, commercial metadata for the candidate dataset; determining, at the processor, field consistency metadata of the candidate dataset based on a predetermined plurality of fields, wherein the metadata comprises the classification metadata, the coverage metadata, the timestamp density metadata, the commercial metadata and the field consistency metadata.

In one or more embodiments, the dataset listing request may further comprise an ephemeral copy of the dataset, and the platform node may generate the dataset quality score based on the ephemeral copy of the dataset.

In one or more embodiments, the generating of the dataset, sending the dataset, and the sending the dataset listing request may be performed by a provider agentic system at the data provider node.

In one or more embodiments, the provider agentic system may negotiate with a consumer agentic system to thereby perform at least one selected from the group of: generate the recorded purchase state, request clarification metadata, and propose modified commercial parameters subject to at least one constraint defined by organizational policy or governance state.

In one or more embodiments, the dataset listing request may be received by a platform agentic system at the platform node node.

In one or more embodiments, prior to emitting the access-key payload, the smart contract may enforce an escrow challenge window and, upon detection of a dispute event recorded on-chain during the challenge window, withholds or replaces the access-key payload until a resolution state is recorded by at least one selected from the group of: the smart contract and the platform node.

In one or more embodiments, the processor may bind the access-key payload to a license tier stored in either on- or off-chain state for the listing identifier, the license tier defining at least one of: permitted use categories, access duration, or volume limits, and wherein the access-key payload may be rendered invalid if a license violation state is recorded.

In one or more embodiments, the candidate dataset may be a streaming candidate dataset.

In one or more embodiments, the processor may rotate a stream access key by emitting successive access-key payloads upon recording periodic usage or settlement states from the smart contract for the listing identifier, thereby enabling access to time-segmented portions of the streaming candidate dataset.

In one or more embodiments, the candidate dataset may be secured at the off-chain storage node based on the access identifier for the off-chain storage node.

In one or more embodiments, the method may further comprise: monitoring, at the processor, on-chain state recorded by the smart contract; and responsive to a detected purchase completion state, generating and transmitting the access-key payload for off-chain dataset retrieval, wherein the monitoring and transmission may be performed off-chain by the platform node processor without execution of application logic on the blockchain.

In one or more embodiments, the platform node may operate based on a governance state recorded on-chain, the governance state derived from token-weighted voting and defining at least one of: listing eligibility rules, fee parameters, dispute handling rules, or agent execution permissions.

In a second aspect, there is provided a data provider system for sharing a candidate dataset, comprising: a memory of a data provider node; and a processor of the data provider node in communication with the memory, the processor configured to: receive the candidate dataset and metadata associated with the candidate dataset; send to an off-chain storage node, the dataset secured at the off-chain storage node based on an access identifier for the off-chain storage node; generate a listing identifier and an integrity reference linking the metadata to the dataset in the off-chain storage node; send to a platform node, a dataset listing request comprising the listing identifier, the metadata and the integrity reference linking the metadata to the dataset in the off-chain storage node; and receive based on the dataset listing request, a dataset listing response comprising a confirmation from the platform node that the dataset has been registered and stored, wherein when the processor receives a recorded purchase state associated with the listing identifier from a smart contract, emitting to a buyer wallet address an access-key payload comprising the access identifier that is usable by a consumer node associated with the buyer wallet address to access the dataset at the off-chain storage node.

In one or more embodiments, the dataset listing request may further comprise the metadata, the integrity reference to the location of the dataset at the off-chain storage node, wherein the metadata used by the platform node to generate a dataset quality score for comparative ranking and pricing of the dataset without revealing an identity of the data provider node, the data consumer node, and the platform node.

In one or more embodiments, the processor may be further configured to: determine classification metadata for the candidate dataset; determine coverage metadata for the candidate dataset; determine timestamp density metadata of the candidate dataset; determine commercial metadata for the candidate dataset; and determine field consistency metadata of the candidate dataset based on a predetermined plurality of fields, wherein the metadata comprises the classification metadata, the coverage metadata, the timestamp density metadata, the commercial metadata and the field consistency metadata, and wherein the dataset listing request further comprises an ephemeral copy of the dataset, and the platform node generates the dataset quality score based on the ephemeral copy of the dataset.

In one or more embodiments, the generating of the dataset, sending the dataset, and the sending the dataset listing request may be performed by a provider agentic system at the data provider node.

In one or more embodiments, the provider agentic system may negotiate with a consumer agentic system to thereby perform at least one selected from the group of: generate the recorded purchase state, request clarification metadata, and propose modified commercial parameters subject to at least one constraint defined by organizational policy or governance state.

In one or more embodiments, the dataset listing request may be received by a platform agentic system at the platform node.

In one or more embodiments, prior to emitting the access-key payload, the smart contract may enforce an escrow challenge window and, upon detection of a dispute event recorded on-chain during the challenge window, withholds or replaces the access-key payload until a resolution state is recorded by at least one selected from the group of: the smart contract and the platform node.

In one or more embodiments, the processor may bind the access-key payload to a license tier stored in either on- or off-chain state for the listing identifier, the license tier defining at least one of: permitted use categories, access duration, or volume limits, and wherein the access-key payload is rendered invalid if a license violation state is recorded.

In one or more embodiments, the candidate dataset may be a streaming candidate dataset.

In one or more embodiments, the processor may rotate a stream access key by emitting successive access-key payloads upon recording periodic usage or settlement states from the smart contract for the listing identifier, thereby enabling access to time-segmented portions of the streaming candidate dataset.

In one or more embodiments, the processor may be further configured to: monitor on-chain state recorded by the smart contract; and responsive to a detected purchase completion state, generate and transmit the access-key payload for off-chain dataset retrieval, wherein the monitoring and transmission are performed off-chain by the platform node processor without execution of application logic on the blockchain.

In one or more embodiments, the platform node may operate based on a governance state recorded on-chain, the governance state derived from token-weighted voting and defining at least one of: listing eligibility rules, fee parameters, dispute handling rules, or agent execution permissions.

In a third aspect, there is provided a computer-readable media for sharing a candidate dataset at a data provider node, comprising instructions that when executed cause a processor to perform any of the methods described herein.

### BRIEF DESCRIPTION OF THE DRAWINGS

Having thus generally described the nature of the invention, reference will now be made to the accompanying drawings, showing by way of illustration example embodiments thereof and in which:

FIG. 1 shows a system diagram of a system for sharing a candidate dataset at a data provider node in accordance with one or more embodiments.

FIG. 2 shows a device diagram for the producer device 102 in FIG. 1 in accordance with one or more embodiments.

FIG. 3 shows a method diagram for sharing a candidate dataset at a data provider node in accordance with one or more embodiments.

FIGS. 4-9 show various architecture diagrams for sharing a candidate dataset in accordance with one or more embodiments.

FIGS. 10-17 show various user interface diagrams for sharing a candidate dataset in accordance with one or more embodiments.

### DETAILED DESCRIPTION

Various embodiments will now be described below to provide an example of the claimed user matter. No example described below limits any claimed user matter and any claimed user matter may cover embodiments such as systems or methods that differ from those described below.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g., 112a, or 1121). Multiple elements herein may be identified by part numbers that share a base number in common and that differ by their suffixes (e.g., 1121, 1122, and 1123). All elements with a common base number may be referred to collectively or generically using the base number without a suffix (e.g., 112).

The example systems and methods described herein may be implemented in hardware or software, or a combination of both. In some cases, the examples described herein may be implemented, at least in part, by using one or more computer programs, executing on one or more programmable devices comprising at least one processing element, a data storage element (including volatile and nonvolatile memory and/or storage elements), and at least one communication interface.

These devices may also have at least one input device (e.g., a keyboard, a mouse, a touchscreen, and the like), and at least one output device (e.g., a display screen, a printer, a wireless radio, and the like) depending on the nature of the device. For example, and without limitation, the programmable devices (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some examples, the communication interface may be a network communication interface. In examples in which elements are combined, the communication interface may be a software communication interface, such as those for inter-process communication (IPC). In still other examples, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural, declarative, functional or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Examples of the system may also be considered to be implemented as a non-transitory computer-readable storage medium, configured with a computer program, where the storage medium so configured causes a computer to operate in a specific and predefined manner to perform the functions described herein.

Furthermore, the example system, processes and methods are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various examples of systems, methods and computer programs products are described herein. Modifications and variations may be made to these examples without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be used with alternative implementations of the systems and methods described herein.

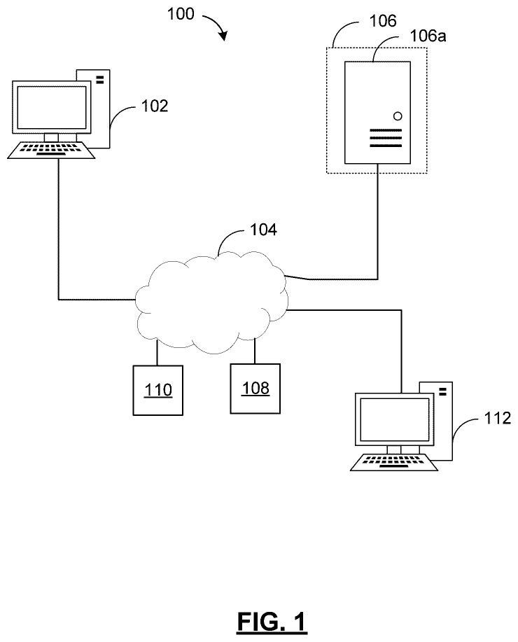

Referring first to FIG. 1, there is shown a system diagram 100 of a system for sharing a candidate dataset at a data provider node in accordance with one or more embodiments. The system diagram 100 of a system for sharing a candidate dataset at a data provider node 102 in accordance with one or more embodiments. The system facilitates secure and privacy-preserving exchange of datasets between a data provider and a data consumer, leveraging decentralized and off-chain components.

The system includes a data provider node 102, which is operated by a data-providing organization. The data provider node 102 is responsible for preparing and submitting datasets, along with associated metadata, to the platform. The metadata includes classification, coverage, and commercial attributes, which are used for listing and discovery purposes. The data provider node 102 interacts with other components of the system through a network 104. The data provider node 102 may be used by a user such as a technician, an employee of the data providing organization, an administrator, or other individual to access a software application (not shown) running on platform 106a at remote service 106 over network 104.

In one embodiment, the data provider node 102 may be a computer device and may access a web application hosted at server 106a using a browser for listing datasets on platform node 106a to the users at data consumer nodes 112. In an alternate embodiment, the data provider node 102 device may download an application (including downloading from an App Store such as the Apple® App Store or the Google® Play Store) for sharing datasets.

The data provider node 102 may be a computer device such as a Windows®-based computer or a Apple® Mac computer as known.

The data provider node 102 may be in communication with one or more industrial devices, sensors, or commercial devices that generate datasets. For example, the data provider node 102 may be in communication with a pump system and associated sensors at data providing organization. The data provider node 102 may be used to download the datasets from a device at the data providing organization, may edit or review the datasets in preparation for sharing as described herein. The user of the data provider node 102 may be associated with a provider wallet that is associated with the smart contract system 110 or blockchain underlying the smart contract system 110.

The data provide node 102 may store datasets at off-chain storage system 108. By way of example, dataset formats may include structured tabular files such as comma-separated values (CSV) and spreadsheet workbooks (XLSX), time-series log files encoded as delimited text, and image files such as PNG or JPEG that serve as supporting artifacts or annotations; in some cases, a listing may reference stream-oriented payloads delivered through API endpoints for continuous or periodic access, and such streams may be treated as a dataset format for registration and access control purposes.

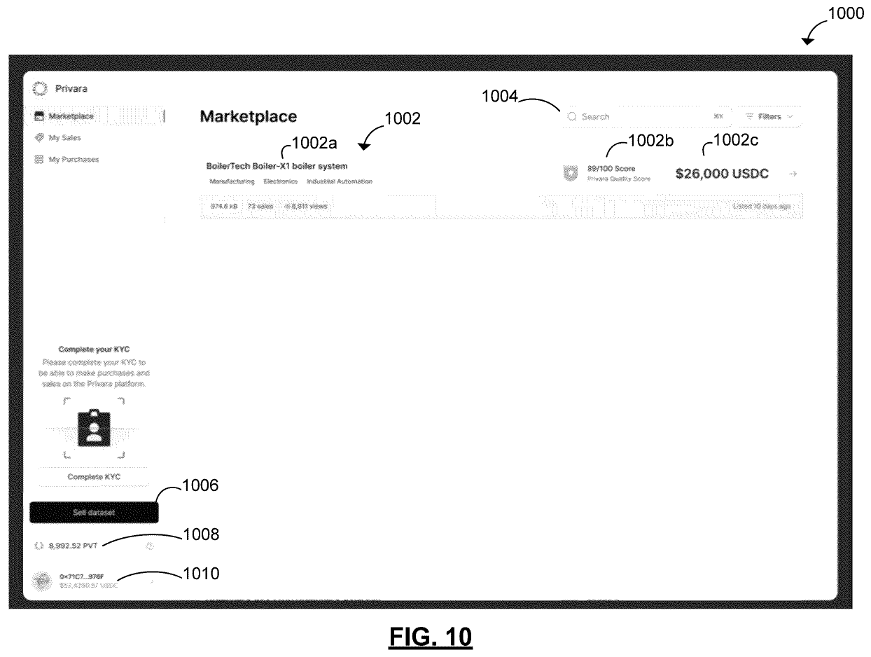

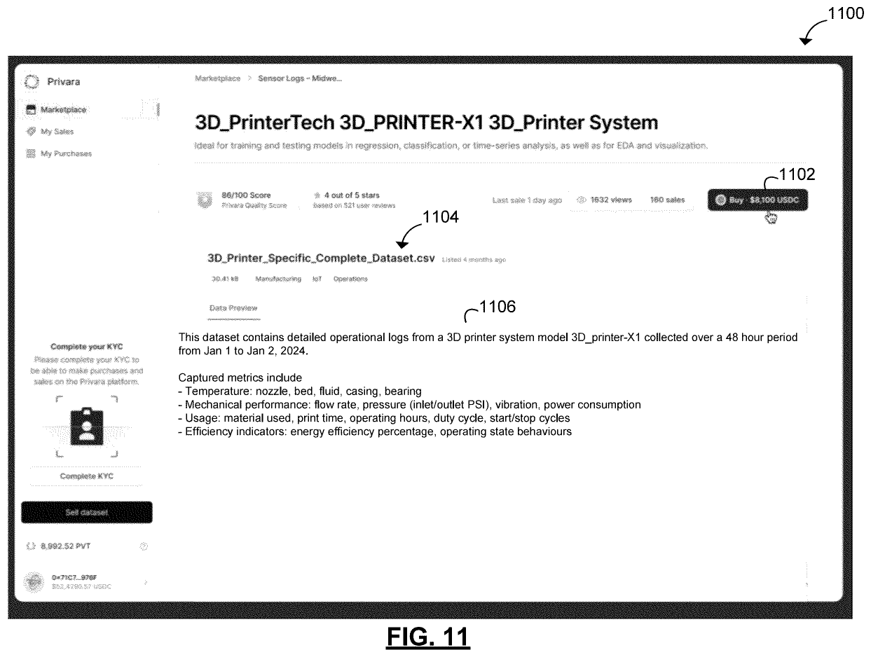

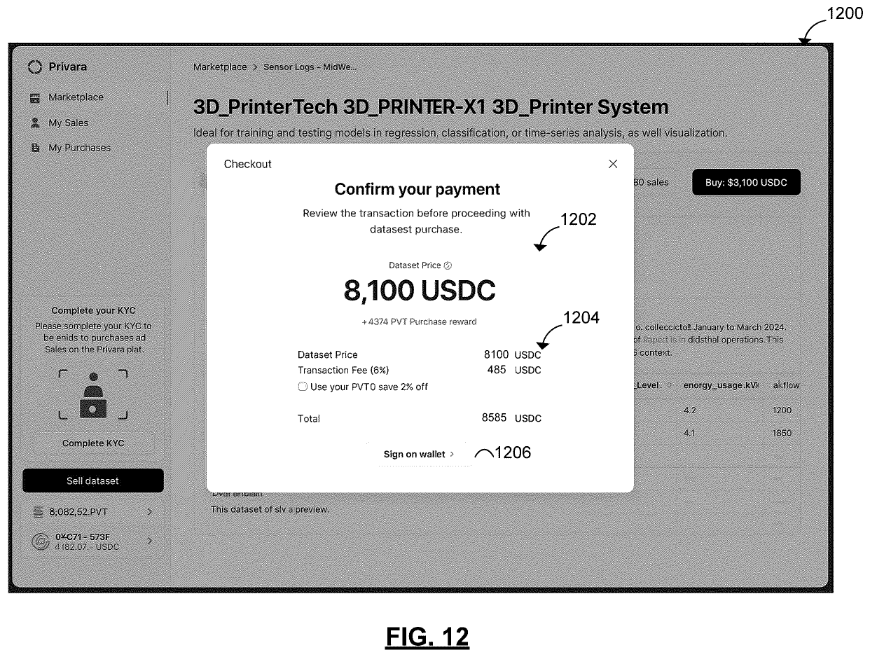

The data provider node 102 may have a display device that may show the user interface in FIGS. 10-17 and described herein.

The network 104 serves as the communication medium connecting the various components of the system. The network 104 facilitates secure data transmission between the data provider node 102, the platform node 106A, the off-chain storage system 108, the smart contract system 110, and the data consumer node 112.

Network 104 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

The remote service 106 may include a remote server colocation or a service such as Amazon® AWS® or Google® Cloud®. The remote server 106 may provide the platform node 106A and one or more databases or data stores.

The platform node 106A, which is part of the remote service 106, functions as the primary coordinator of the system. The platform node 106A processes metadata and dataset payloads received from the data provider node 102. The platform node 106A identifies validated metadata, calculates dataset quality scores, and registers dataset listings through interactions with the smart contract system 110 as described herein. Additionally, the platform node 106A provides compliance with governance rules, oversees licensing constraints, and supports dispute resolution.

The platform node 106a is in network communication via network 104. The platform node 106a may include, or may further be in communication with one or more databases.

The platform node 106a may host a web application or an Application Programming Interface (API) endpoint that the data provider nodes 102 and the data consumer nodes 112 may interact with via network 104. Further, the server 106a may make calls to the smart contract system 110 to when dataset listings are created and when purchases are performed by data consumer node 112. The requests made to the platform node 106a may be made in a variety of different formats, such as JavaScript Object Notation (JSON) or eXtensible Markup Language (XML). The platform node 106A may receive ephemeral copies of the datasets from data provider nodes 102.

The off-chain storage system 108 is used to securely store the dataset payloads submitted by the data provider node 102. The datasets may be protected using access identifiers to provide privacy and prevent unauthorized access. The datasets may be encrypted and stored off-chain to provide privacy and prevent unauthorized access. The platform node 106A may generate time-limited access credentials or signed download links for authorized retrieval of the datasets by the data consumer node 112.

The off-chain storage system 108 may store unencrypted datasets using an access identifier to protect the dataset files. The off-chain storage system 108 may store encrypted dataset files received from the data provider node 102, with the storage location referenced by an integrity value registered by the platform node in the smart contract system 110. The off-chain storage system 108 may maintain privacy by requiring possession of a valid access identifier or time-limited access credential before permitting retrieval of a dataset. These access credentials may be generated by the platform node 106A following detection of a purchase completion state recorded by the smart contract system 110. The off-chain storage system 108 may employ cryptographic controls such as encrypted buckets, signed access URLs, or other controlled retrieval mechanisms to provide that only authorized data consumer nodes 112 are able to obtain the dataset. Raw dataset values stored within the off-chain storage system 108 may remain inaccessible to the smart contract system 110 and may not be publicly exposed.

The off-chain storage system 108 may also support optional features such as access-tier enforcement, time-limited retrieval, and rotating credentials for streaming or periodically updated datasets. In some implementations, the off-chain storage system 108 may provide audit logs that record retrieval events, allowing the platform node 106A to verify compliance with licensing policies anchored to on-chain state. The off-chain storage system 108 may therefore operate as a controlled, privacy-preserving environment that complements the on-chain functionality of the smart contract system 110 by securely storing the dataset payload and enabling conditional release of that payload based on transaction state recorded on-chain. This architecture provides that the raw dataset remains off-chain and protected, while permitting scalable and efficient delivery workflows orchestrated by the platform node. The off-chain storage system 108 may be a distributed file system such as the Interplanetary File System (IPFS).

The smart contract system 110 operates on a blockchain and provides a ledger resistant to tampering for recording transaction states. The system manages escrow and settlement processes, ensuring that funds are securely held and released based on predefined conditions. Additionally, the smart contract system 110 records metadata references and transaction events, linking these to the off-chain storage system 108.

The smart contract system 110 may record listing identifiers, commercial parameters, escrow conditions, fee parameters, and integrity references that link on-chain metadata to the dataset maintained in the off-chain storage system 108. The smart contract system 110 may also enforce conditional settlement by accepting tokenized payments from a consumer wallet and locking such funds until predefined criteria are satisfied, such as confirmation of dataset delivery or expiration of a dispute challenge window. Upon satisfaction of the applicable conditions, the smart contract system 110 may release escrowed funds to a provider wallet and emit a completion event that allows off-chain components to grant access credentials to the corresponding dataset. The smart contract system 110 functions as an authoritative state registry and may be monitored by the platform node 106A or data producer node 102 to detect purchase completion or dispute events.

The smart contract system 110 may be configured so that it does not store or process raw dataset values, identity information, or compliance credentials. Instead, it may store only listing identifiers, escrow state markers, cryptographic integrity references, and references to pseudonymous market participants. The smart contract system 110 may further support multi-stage workflows such as transaction initiation, funding, challenge, resolution, and completion by emitting events that downstream components interpret to authorize dataset access through the off-chain storage system 108. In some implementations, the smart contract system 110 may also store governance state references that define platform rules relating to licensing tiers, transaction fees, and dispute handling. These functions allow the smart contract system 110 to serve as an immutable coordination layer for off-chain processes while maintaining data minimization and privacy boundaries consistent with the system architecture described in FIG. 1.

The data consumer node 112 is operated by a data-consuming organization. The data consumer node 112 may be a computer device, generally similar to the data producer node 102 but located at the data consuming organization. This node allows users to search for, evaluate, and purchase datasets listed on the platform. The data consumer node 112 interacts with the platform node 106A to query metadata, initiate purchases, and retrieve datasets from the off-chain storage system 108. The data consumer node 112 functions under enterprise wallet governance, ensuring adherence to organizational policies. The user of the data consumer node 112 may be associated with a consumer wallet that is associated with the smart contract system 110 or the blockchain underlying the smart contract system 110. In some cases, the data provider nodes 102 may also be data consumer nodes 112 at the same time, where a first dataset is listed and sold, and a second dataset may be purchased by the same data consumer/producer node.

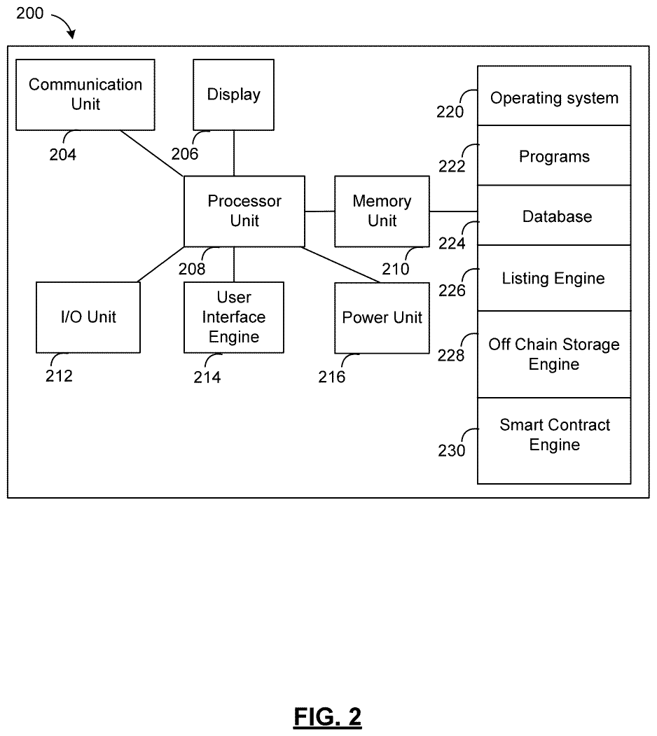

Referring next to FIG. 2, there is shown a device diagram for the producer device 102 in FIG. 1 in accordance with one or more embodiments.

FIG. 2 shows a system architecture block diagram for a producer device 200, which is configured to facilitate the secure and privacy-preserving exchange of datasets in accordance with one or more embodiments. The producer device 200 includes various interconnected components that collectively enable the preparation, submission, and management of datasets and metadata.

The user device 200 may be a laptop, mobile phone device, desktop computer or others as are known.

The communication unit 204 enables the producer device 200 to interact with external systems, such as the central platform, off-chain storage 228, and smart contract systems 230, over a network. This unit provides secure data transmission and supports the exchange of metadata, dataset payloads, and transaction states. The communication unit 204 can include wired or wireless connection capabilities. The communication unit 204 can include a radio that communicates utilizing CDMA, GSM, GPRS or Bluetooth protocol according to standards such as IEEE 802.11a, 802.11b, 802.11g, or 802.11n. The communication unit 204 can be used by the producer device 200 to communicate with other devices or computers.

The display 206 offers a visual interface for users to engage with the producer device 200. The display 206 may show information such as dataset metadata, listing statuses, and transaction confirmations. The display 206 may be an LED or LCD based display and may be a touch sensitive user input device that supports gestures.

The processor unit 208 is responsible for executing instructions and managing the overall operation of the producer device 200. The processor unit 208 coordinates the activities of other components and processes data related to dataset preparation, metadata generation, and transaction workflows. The processor unit 208 controls the operation of the provider device 200. The processor unit 208 can be any suitable processor, controller or digital signal processor that can provide sufficient processing power depending on the configuration, purposes and requirements of the user device 200 as is known by those skilled in the art. For example, the processor unit 208 may be a high-performance general processor. In alternative embodiments, the processor unit 208 can include more than one processor with each processor being configured to perform different dedicated tasks. In alternative embodiments, it may be possible to use specialized hardware to provide some of the functions provided by the processor unit 208. For example, the processor unit 208 may include a standard processor, such as an Intel® processor, or an ARM® processor.

The processor unit 208 can also execute a user interface (UI) engine 214 that is used to generate various Uls, some examples of which are shown and described herein, such as interfaces shown in FIGS. 10-17.

The memory unit 210 stores data and instructions required for the operation of the producer device 200. The memory unit 210 includes both volatile and non-volatile memory for storing the operating system 220, programs 222, and other necessary data such as the database 224. The memory unit 210 comprises software code for implementing an operating system 220, programs 222, database 224, listing engine 226, off-chain storage engine 228 and smart contract engine 230.

The memory unit 210 can include RAM, ROM, one or more hard drives, one or more flash drives or some other suitable data storage elements such as disk drives, etc. The memory unit 210 is used to store an operating system 220 and programs 222 as is commonly known by those skilled in the art.

The I/O unit 212 facilitates input and output operations, allowing users to interact with the producer device 200 through peripherals such as keyboards, mice, or touchscreens. The I/O unit 212 additionally supports the integration of external devices for data transfer or additional functionality.

The user interface engine 214 manages the interaction between the user and the producer device 200. The user interface engine 214 offers an intuitive platform for dataset preparation, metadata submission, and listing management, facilitating a smooth user experience. The user interface engine 214 may include generating the user interfaces found in FIGS. 10-17.

The power unit 216 supplies power to the producer device 200 and provides continuous operation. The power unit 216 may incorporate battery management and power optimization features. The power unit 216 can be any suitable power source that provides power to the provider device 200 such as a power adaptor or a rechargeable battery pack depending on the implementation.

The operating system 220 provides the foundational software environment for the producer device 200, enabling the execution of programs 222 and the management of hardware resources. The operating system 220 may provide various basic operational processes for the user device 200. For example, the operating system 220 may be a mobile operating system such as Google® Android® operating system, or Apple® iOS® operating system, or another operating system. Alternatively, the operating system 220 may be a desktop operating system such as Microsoft® Windows® or Apple® MacOS®.

The programs 222 include various user programs so that a user can interact with the provider device 200 to perform various functions such as, but not limited to, viewing datasets, receiving datasets from various provider devices, receiving any other metadata as the case may be.

The database 224 stores structured data, including metadata, transaction records, and other information required for dataset preparation and listing management. The database 224 facilitates effective data retrieval and storage operations.

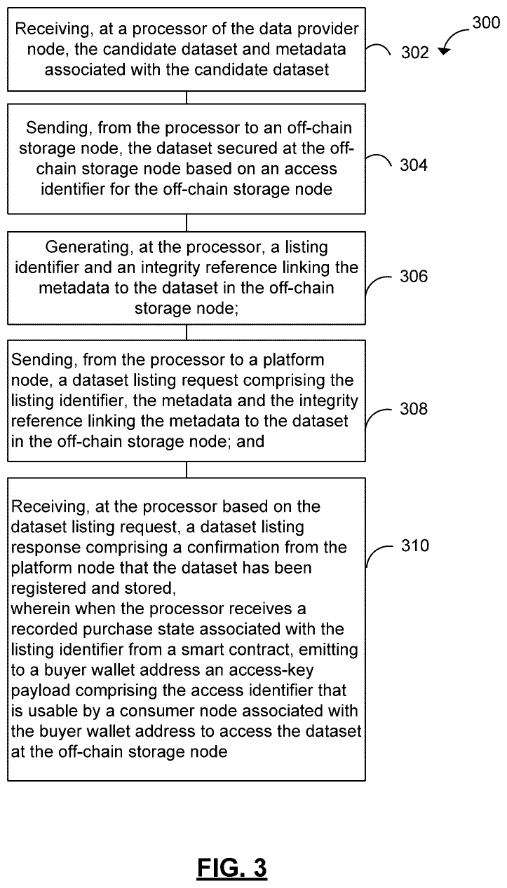

The listing engine 226, off-chain storage engine 228 and the smart contract engine 230 may provide the method of FIG. 3.

The listing engine 226 is responsible for generating and managing dataset listings. The listing engine 226 processes metadata, assigns listing identifiers, and interacts with the platform node 106A and the smart contract system 110 to register listings on the blockchain. The listing engine 226 may communicate with the platform node 106A via communication unit 204 and network 104 (e.g. FIG. 1).

The off-chain storage engine 228 manages the secure storage of dataset payloads. The off-chain storage engine 228 provides that raw datasets remain off-chain and are accessible solely through authorized mechanisms, such as time-limited access credentials. The off-chain storage engine 228 may communicate with the off-chain storage system 108 (e.g. FIG. 1) using communication unit 204 and network 104.

The smart contract engine 230 facilitates interactions with the blockchain layer. The smart contract engine 230 generates and executes smart contracts for recording transaction states, managing escrow, and enforcing licensing and governance rules. The smart contract engine 230 may communicate with the smart contract system 110 (e.g. FIG. 1) using communication unit 204 and network 104.

Referring next to FIG. 3 shows a method diagram for sharing a candidate dataset at a data provider node in accordance with one or more embodiments.

FIG. 3 shows a flowchart illustrating a method for sharing a candidate dataset at a data provider node 102 in accordance with one or more embodiments. The method involves a sequence of steps executed by a processor 208 at the data provider node 102 to facilitate secure and privacy-preserving dataset exchange.

At 302, receiving, at a processor of the data provider node, the candidate dataset and metadata associated with the candidate dataset. At the initial step, the processor 208 of the data provider node 102 receives the candidate dataset along with the associated metadata. The metadata may include classification, coverage, and commercial attributes, which are necessary for listing and discovery purposes. This may prepare the dataset and the descriptive attributes are for subsequent processing and secure storage.

At 304, sending, from the processor to an off-chain storage node, the dataset secured at the off-chain storage node based on an access identifier for the off-chain storage node. The processor 208 sends the dataset to an off-chain storage node 108, where the dataset is securely stored. The dataset may be protected using an access identifier specific to the off-chain storage node 108, ensuring unauthorized access is prevented. This step may separates the raw dataset from the blockchain layer, maintaining privacy and scalability.

At 306, generating, at the processor, a listing identifier and an integrity reference linking the metadata to the dataset in the off-chain storage node. The processor 208 generates a distinct listing identifier and an integrity reference that links the metadata to the dataset stored in the off-chain storage node 108. The integrity reference provides that the dataset's authenticity and integrity can be verified, providing a cryptographic link between the metadata and the dataset.

At 308, sending, from the processor to a platform node, a dataset listing request comprising the listing identifier, the metadata and the integrity reference linking the metadata to the dataset in the off-chain storage node. The processor 208 sends a dataset listing request to a platform node 106A. This request includes the listing identifier, the metadata, and the integrity reference. The platform node 106A uses this information to register the dataset listing, enabling the discoverability of the dataset by potential data consumers. The listing request provides the dataset is properly indexed and available for transactions.

At 310, receiving, at the processor based on the dataset listing request, a dataset listing response comprising a confirmation from the platform node that the dataset has been registered and stored, wherein when the processor receives a recorded purchase state associated with the listing identifier from a smart contract, emitting to a buyer wallet address an access-key payload comprising the access identifier that is usable by a consumer node associated with the buyer wallet address to access the dataset at the off-chain storage node. Upon receiving the dataset listing request, the platform node 106A processes the request and sends a dataset listing response to the processor 208. This response confirms that the dataset has been successfully registered and stored. When the processor 208 detects a recorded purchase state associated with the listing identifier from a smart contract 110, it emits an access payload to a buyer wallet address. This payload includes the access identifier, which enables the consumer node 112 associated with the buyer wallet address to retrieve the dataset from the off-chain storage node 108. This step provides secure and authorized access to the dataset while maintaining the privacy of the data provider node 102 and consumer node 112.

In one or more embodiments, the dataset listing request may further comprise the metadata, the integrity reference to the location of the dataset at the off-chain storage node, wherein the metadata used by the platform node to generate a dataset quality score for comparative ranking and pricing of the dataset without revealing an identity of the data provider node, the data consumer node, and the platform node.

The dataset listing request may further comprise the metadata that characterizes a candidate dataset, including classification metadata, coverage metadata, timestamp density metadata, commercial metadata, and field consistency metadata, each of which may be determined by a processor at the data provider node 102 before transmission. The inclusion of the metadata in the dataset listing request sent to the platform node 106A allows the platform node 106A to register the dataset, generate comparative quality indicators, and make the dataset discoverable to potential data consumer nodes 112. As an example, the dataset listing request may include metadata indicating that the dataset corresponds to a rotary-pump subsystem, captured at one-second intervals over a two-week period, with consistent field structure and an associated licensing tier. This metadata may accompany the listing identifier and the integrity reference used to link the metadata to the dataset stored in the off-chain storage system 108.

In some implementations, the dataset listing request may also include an ephemeral copy of the dataset for the limited purpose of enabling the platform node 106A to perform transient operations such as metadata validation or preliminary dataset scoring. This ephemeral copy may be discarded after processing, with only the metadata and integrity reference retained for subsequent listing and discovery. For example, the dataset listing request may include a transient sample of 100 rows of time-series measurements that allows the platform node 106A to confirm timestamp regularity or schema conformance before registering the listing on the smart contract system 110.

The generation of the dataset quality score by the platform node 106A may involve evaluating metadata attributes and structural characteristics associated with the candidate dataset received from the data provider node 102. The platform node 106A may compute quality indicators such as metadata completeness, timestamp density, anonymization reliability, structural completeness, and field consistency. The platform node 106A may then aggregate these indicators into a composite dataset quality score that can be associated with the listing identifier recorded in the smart contract system 110. As an example, the platform node 106A may determine that a dataset containing vibration and pressure readings demonstrates high temporal density but moderate field consistency, resulting in a composite dataset quality score of 82 on a 0 to 100 scale.

A metadata completeness score may quantify the proportion of required metadata fields that contain valid values for a dataset category. Let R denote the total count of required metadata fields and F denote the count of required fields populated with valid values. The metadata completeness score may be computed as:

$$Metadata\_Completeness = F / R$$

The result may be normalized to the range [0.0,1.0] for downstream use.

A schema quality score may measure alignment between a declared category schema and the observed dataset schema. Let C_{required} be the set of required columns for the category and C_{observed} the set of columns parsed from the dataset. Let C_{documented} be the number of observed columns that have defined unit and type documentation. The required-column match ratio and documentation ratio may be computed and combined as follows:

$$Required\_Column \_Match \_Ratio = \vert C\_required ⋂ C\_observed \vert / \vert C\_required \vert$$

$$Documentation\_Ratio = C\_documented / \vert C\_observed \vert$$

$$Schema\_Quality = ( {0.7}^{*} Required\_Column \_Match \_Ratio ) + ( {0.3}^{*} Documentation\_Ratio )$$

The result may be clamped to [0.0, 1.0]

A structural completeness score may evaluate the presence of valid values across required columns. For a dataset with N rows and a required column set [symbol] , define for each column c∈ [symbol] a missing rate missing_rate(c)=missing_count(c)/N, where missing_count(c) represents a number of rows in which a value for column c is absent or invalid, and a weight w(c). The score may be computed as:

$$Structural\_Completeness = 1 - \sum \_c [ {w ( c )}^{*} missing\_rate ( c ) ]$$

The result may be clamped to [0.0,1.0].

A temporal density score may measure sampling regularity and continuity for time-series data. Let timestamps be sorted as tᵢ and inter-arrival intervals Δᵢ=tᵢ₊₁−tᵢ. Let Δ_{med} denote the median of Δᵢ. Define:

$$regular\_intervals = \# \{ {Δ}_{i} \vert 0.5 {Δ}_{med} \leq {Δ}_{i} \leq 2 {Δ}_{med} \}$$

$$gap\_events = \# \{ {Δ}_{i} \vert {Δ}_{i} > gap\_threshold \} with gap\_threshold = 10 {Δ}_{med}$$

$$total\_intervals = number of {Δ}_{i} values$$

$$Regularity\_Ratio = regular\_intervals / total\_intervals$$

$$Gap\_Rate = gap\_events / total\_intervals$$

$$Temporal\_Score = ( {0.5}^{*} Regularity\_Ratio ) + ( {0.5}^{*} ( 1 - Gap\_Rate ) )$$

The result may be clamped to [0.0, 1.0]

A consistency and validity score may measure conformance of values to declared types and category bounds. For a dataset with N rows and required columns [symbol] , define for each column c∈ [symbol] a validity rate validity_rate(c)=valid_count(c)/N, where valid_count(c) represents a number of rows containing values that conform to declared data types and category-defined bounds, and a weight w(c). The score may be computed as:

$$Consistency\_Validity = \sum \_c [ {w ( c )}^{*} validity\_rate ( c ) ]$$

The result may be clamped to [0.0, 1.0].

A duplication score may measure the degree of excessive duplicate records. Given a deterministic sample S of rows and H unique row hashes within that sample:

$$Duplication\_Rate = 1 - ( H / \vert S \vert )$$

$$Duplication\_Score = 1 - Duplication\_Rate$$

The result may be clamped to [0.0,1.0].

A recency score may quantify how recent a dataset is relative to an evaluation time. Let tₘₐₓ denote the most recent timestamp in the dataset and let age_days=current_date−tₘₐₓ measured in days. The score may be computed as:

$$Recency = exp ( - age\_days / 180 )$$

The result may be clamped to [0.0, 1.0]

A composite score may aggregate normalized sub-scores into a single value suitable for ranking. Let M be the metadata completeness score, S the schema quality score, C the structural completeness score, T the temporal density score, V the consistency and validity score, D the duplication score, and R the recency score. The composite score may be computed as:

$$Composite = ( {0.2}^{*} M ) + ( {0.1}^{*} S ) + ( {0.2}^{*} C ) + ( {0.2}^{*} T ) + ( {0.15}^{*} V ) + ( {0.1}^{*} D ) + ( {0.05}^{*} R )$$

The composite value may optionally be scaled to a 0 to 100 range for presentation.

The dataset quality score may be generated transiently, without storing raw dataset payloads, and may rely solely on metadata and constrained structural characteristics. The score may be recorded off-chain in association with the listing metadata and referenced by the smart contract system 110. As an example, the platform node 106A may receive a metadata set indicating a twelve-hour coverage period, uniform sampling, and high completeness, leading the platform node 106A to generate and store a dataset quality score that may later be used for discovery prioritization or pricing guidance presented to a data consumer node 112.

The ranking of datasets at the platform node 106A when a data consumer node 112 searches for datasets may be based on metadata, the dataset quality score, and other contextual attributes related to the consumer's search criteria. The platform node 106A may compare the quality scores, classification metadata, coverage periods, and commercial attributes of potential matches to determine a ranked ordering for presentation to the data consumer node 112. As an example, when a data consumer node 112 searches for datasets related to centrifugal pumps, the platform node 106A may rank listings with higher dataset quality scores, more complete metadata, and more recent coverage above lower-scoring or less complete listings.

The ranking process may allow the platform node 106A to incorporate additional optional factors, such as licensing compatibility, dataset recency, or accumulated marketplace signals, so long as such factors do not require access to raw dataset payloads. For example, if multiple datasets exhibit similar quality scores, the platform node 106A may prioritize datasets with higher temporal completeness or more consistent metadata fields. In doing so, the platform node 106A may provide the data consumer node 112 with a structured, privacy-preserving discovery experience in which datasets most likely to meet the consumer's requirements appear earlier in the ranked results.

In one or more embodiments, the method may further comprise: determining, at the processor, classification metadata for the candidate dataset; determining, at the processor, coverage metadata for the candidate dataset; determining, at the processor, timestamp density metadata of the candidate dataset; and determining, at the processor, commercial metadata for the candidate dataset; determining, at the processor, field consistency metadata of the candidate dataset based on a predetermined plurality of fields, wherein the metadata comprises the classification metadata, the coverage metadata, the timestamp density metadata, the commercial metadata and the field consistency metadata.

Classification metadata for the candidate dataset may identify a technical domain and category that characterize the dataset for discovery and governance. A processor at the data provider node 102 may determine a category label, related equipment or subsystem identifiers, and data modality descriptors, and may include these attributes in a dataset listing request transmitted to the platform node 106A. The platform node 106A may record a listing identifier in the smart contract system 110 and associate the classification metadata with an integrity reference that links to the encrypted payload in the off-chain storage system 108. For example, a dataset captured from a centrifugal pump may be classified under manufacturing and rotating equipment with modalities that include pressure, vibration, and motor current, enabling the platform node 106A to index and surface the listing when a data consumer node 112 queries for pump data.

Coverage metadata for the candidate dataset may specify a temporal span and, when applicable, a scope dimension such as operating context or geography. The data provider node 102 may generate start and end timestamps, indicate total duration, and optionally include location or asset-fleet tags before sending the dataset listing request to the platform node 106A. The platform node 106A may store the coverage metadata off-chain and refer to it on-chain via a listing identifier in the smart contract system 110, which may be used during ranking and policy checks prior to granting access to the dataset stored in the off-chain storage system 108. As an example, coverage metadata may indicate that the dataset contains 48 hours of one-second telemetry from a 3D printer at an industrial facility, which allows the platform node 106A to surface results matching requested duration thresholds from a data consumer node 112.

Timestamp density metadata of the candidate dataset may quantify sampling characteristics such as nominal sampling interval, regularity, gaps, and continuity. The data provider node 102 or the platform node 106A may derive a median inter-sample interval and compute indicators of gap frequency and burstiness, which may then be included in the dataset listing request or computed transiently for quality scoring. These density indicators may be referenced by the platform node 106A during search to prefer datasets that meet a data consumer node 112 request for specific sampling regimes, while leaving the encrypted payload secured in the off-chain storage system 108 and only anchoring state in the smart contract system 110. For example, timestamp density metadata may indicate a one-second nominal interval with less than two percent gaps over a seven-day window, which may contribute to a higher quality assessment for continuous process monitoring use cases.

Commercial metadata for the candidate dataset may describe pricing parameters, licensing tier, permitted use categories, and optional access duration or volume limits. The data provider node 102 may supply these attributes with the dataset listing request to the platform node 106A, which may record a corresponding state on the smart contract system 110 and enforce related conditions during purchase and access orchestration. The platform node 106A may later bind authorized access keys for the off-chain storage system 108 to the selected licensing tier and permitted use categories after a purchase completion event is detected on the smart contract system 110. As an example, commercial metadata may set a price in tokenized stablecoin, designate a research-only license with no redistribution, and specify a 30-day access window, allowing the platform node 106A to verify compliance prior to returning time-limited access credentials to a data consumer node 112.

Field consistency metadata of the candidate dataset based on a predetermined plurality of fields may quantify schema conformance, value validity, and missingness across required columns defined for a dataset category. A predetermined field set may be established by the platform node 106A for a given classification, and the data provider node 102 or the platform node 106A may compute per-field indicators such as type adherence, unit compatibility, and percentage of valid values. These consistency metrics may be associated with the listing identifier stored in the smart contract system 110 and may be used by the platform node 106A to influence ranking when a data consumer node 112 searches for datasets, while the raw values remain encrypted in the off-chain storage system 108. For example, a pump telemetry dataset may be evaluated against a required field set that includes timestamp, inlet pressure, outlet pressure, flow rate, and motor current, and the field consistency metadata may report that all required fields are present with greater than ninety-five percent valid entries and unit-consistent ranges.

In one or more embodiments, the dataset listing request may further comprise an ephemeral copy of the dataset, and the platform node may generate the dataset quality score based on the ephemeral copy of the dataset.

An ephemeral copy of the dataset may be a transient subset or duplicate of the candidate dataset that is transmitted by the data provider node 102 to the platform node 106A for limited processing such as metadata validation and preliminary scoring, after which the ephemeral copy may be discarded without persistent retention by the platform node 106A. The ephemeral copy may accompany a dataset listing request that also comprises the metadata and an integrity reference linking that metadata to the encrypted payload stored in the off-chain storage system 108, while the smart contract system 110 may record a listing identifier and state transitions used to coordinate subsequent access control. For example, the data provider node 102 may include an ephemeral sample of several hundred time-series rows with the dataset listing request, allowing the platform node 106A to verify timestamp regularity and schema conformance prior to registering the listing and anchoring a corresponding reference in the smart contract system 110, after which the platform node 106A may purge the sample and rely on the integrity reference for continued linkage to the off-chain storage system 108.

The platform node 106A may generate a dataset quality score by evaluating the ephemeral copy of the dataset against one or more quality indicators that may include metadata completeness, timestamp density, structural completeness, and field consistency, while avoiding retention of raw values beyond the processing interval. The resulting score may be associated off-chain with the listing identifier and referenced on-chain through the smart contract system 110, enabling later discovery and ranking without exposing the underlying payload stored in the off-chain storage system 108. As an example, the platform node 106A may compute per-metric sub-scores from the ephemeral copy, aggregate them into a composite dataset quality score, and store that value with the listing metadata so that a data consumer node 112 can later discover and compare listings based on standardized quality criteria while the encrypted dataset remains available through the off-chain storage system 108.

In one or more embodiments, the generating of the dataset, sending the dataset, and the sending the dataset listing request may be performed by a provider agentic system at the data provider node.

A provider agentic system at the data provider node 102 may automate generation of a candidate dataset, preparation of associated metadata, and orchestration of submission activities that include sending the dataset and transmitting a dataset listing request. The provider agentic system at the data provider node 102 may package the dataset for secure storage by the off-chain storage system 108, obtain or reference an access identifier for later retrieval, generate a listing identifier and an integrity reference that links the metadata to the stored dataset, and send a dataset listing request to the platform node 106A comprising the listing identifier, the metadata, and the integrity reference. The platform node 106A may then cause the smart contract system 110 to record state for listing registration while the raw dataset remains stored in the off-chain storage system 108.

By way of example, the provider agentic system at the data provider node 102 may detect availability of a new time-series file produced by an industrial controller, derive classification, coverage, timestamp density, and field-consistency indicators, encrypt and send the dataset to the off-chain storage system 108, and construct the dataset listing request with the listing identifier and integrity reference for transmission to the platform node 106A. After the smart contract system 110 records a purchase completion state for the listing, the provider agentic system at the data provider node 102 may respond by causing an access-key payload that embeds the access identifier to be emitted to a buyer wallet address, enabling a consumer node to retrieve the dataset from the off-chain storage system 108 under the recorded transaction state.

In one or more embodiments, the provider agentic system may negotiate with a consumer agentic system to thereby perform at least one selected from the group of: generate the recorded purchase state, request clarification metadata, and propose modified commercial parameters subject to at least one constraint defined by organizational policy or governance state.

A provider agentic system at the data provider node 102 may negotiate with a consumer agentic system at the data consumer node 112 through message exchanges coordinated by the platform node 106A to automate at least one of the following actions: generate a recorded purchase state on the smart contract system 110, request clarification metadata related to the dataset and its schema, and propose modified commercial parameters that remain within constraints defined by organizational policy or a governance state. The governance state may be stored off-chain and anchored on-chain so that the smart contract system 110 and the platform node 106A can reference applicable limits such as discount bands, licensing scope, or approval thresholds without disclosing legal identities or raw payloads stored in the off-chain storage system 108. These negotiations may be logged under pseudonymous identifiers, with outcomes referenced on-chain as transaction state while dataset access continues to be administered off-chain.

By way of example, the provider agentic system at the data provider node 102 may receive, from the consumer agentic system at the data consumer node 112, a clarification request asking for timestamp spacing and units for a pump telemetry dataset. The provider agentic system at the data provider node 102 may respond with the requested metadata and propose a price adjustment and a 30-day access duration that comply with a policy allowing up to a ten percent discount and research-only licensing, after which the consumer agentic system at the data consumer node 112 may accept the terms and cause escrow funding on the smart contract system 110. Upon confirmation of the recorded purchase state by the smart contract system 110, the platform node 106A may authorize issuance of time-limited access credentials to the off-chain storage system 108 for retrieval of the purchased dataset.

In one or more embodiments, the dataset listing request may be received by a platform agentic system at the platform node node.

The dataset listing request may be received by a platform agentic system operating at the platform node 106A, which may parse the request, validate the included metadata and integrity reference, and optionally process an ephemeral copy for transient checks such as schema conformance or preliminary scoring. The platform agentic system at the platform node 106A may then register the listing by interacting with the smart contract system 110 to record a listing identifier and transaction parameters, while linking those on-chain markers to the encrypted payload stored in the off-chain storage system 108. The platform agentic system at the platform node 106A may store derived quality signals and use them later for discovery and ranking without persisting raw dataset values.

As an example, the data provider node 102 may transmit a dataset listing request that includes classification metadata, coverage details, an integrity reference to the object stored in the off-chain storage system 108, and a listing identifier. The platform agentic system at the platform node 106A may validate the integrity reference, compute a dataset quality score from the ephemeral copy if present, and cause the smart contract system 110 to record listing state so that the dataset becomes discoverable to the data consumer node 112 through metadata-based search and ranking.

In one or more embodiments, prior to recording a transaction state associated with the access-key payload, the smart contract may enforce an escrow challenge window and, upon detection of a dispute event recorded on-chain during the challenge window, withholds or replaces the access-key payload authorization until a resolution state is recorded by at least one selected from the group of: the smart contract and the platform node.

An escrow challenge window may be enforced by the smart contract system 110 to provide a defined period during which a dispute related to a listing identifier can be raised and recorded on-chain before settlement is finalized. During this interval, the smart contract system 110 may maintain escrowed funds without release and may emit state markers that the platform node 106A monitors to coordinate downstream off-chain actions, including access authorization for data stored in the off-chain storage system 108. For example, after the data consumer node 112 completes a purchase, the smart contract system 110 may record a funded state and begin a 24-hour challenge window, during which a dispute entry recorded on-chain would halt settlement until a resolution state is reached.

Upon detection of a dispute recorded during the escrow challenge window, the platform node 106A may withhold or replace an access-key payload that would otherwise enable retrieval of the dataset from the off-chain storage system 108, and may continue to do so until a resolution state is recorded by at least one of the smart contract system 110 or the platform node 106A. In an example, where the data consumer node 112 asserts non-conformity within the challenge period, the platform node 106A may issue a substitute, limited-scope access-key payload that permits only preview retrieval, and then either reinstate full access or permanently withhold access based on the resolution state emitted by the smart contract system 110 or determined off-chain by the platform node 106A.

The escrow and dispute resolution workflow may be implemented so that payment release is non-custodial and verifiable while preserving participant anonymity. A data consumer node 112 may fund an escrow held by the smart contract system 110 operating on the blockchain layer 410, with consideration represented in the token layer 408. The smart contract system 110 may record an escrow initialization that includes a buyer identifier, a seller identifier, an amount, a content identifier for an object stored in the off-chain storage system 108, and a timeout parameter. The platform node 106A may monitor the blockchain layer 410 for escrow state transitions and may coordinate off-chain actions such as access authorization and dispute handling without exposing raw dataset payloads.

For a static dataset, settlement release may be conditioned on a delivery confirmation recorded to the smart contract system 110. After the data consumer node 112 retrieves the encrypted dataset from the off-chain storage system 108 and confirms successful decryption, the platform node 106A may cause a delivery confirmation to be written on the blockchain layer 410, which the smart contract system 110 may interpret as sufficient to release escrowed funds to the data provider node 102. As an example, an escrow may be initialized with a listing amount and a timeout, the data consumer node 112 may download and decrypt the object referenced by a content identifier, and a confirmation recorded before the timeout may trigger a release event that the token layer 408 settles to the data provider node 102.

For a streaming dataset, delivery verification may be based on usage signals rather than a single receipt event. A usage oracle integrated with the platform node 106A may report consumption metrics, such as a stream identifier and an amount of data transferred, to the smart contract system 110 on the blockchain layer 410. The smart contract system 110 may accumulate these reports and may authorize proportional or periodic releases from escrow when usage thresholds are met. In some configurations, the platform node 106A may accompany usage reports with a zero-knowledge proof that demonstrates that metering conditions were satisfied without revealing stream contents stored in the off-chain storage system 108. As an example, when the data consumer node 112 consumes a defined number of megabytes from a stream referenced by a listing identifier, the usage oracle may emit a report that allows the smart contract system 110 to release a corresponding portion of the escrowed amount. In contrast to static datasets associated with a single delivery event, streaming datasets are accessed under an ongoing entitlement in which verification and settlement are based on observed usage over time.

A timeout condition may serve as a failsafe for both static and streaming cases. If the smart contract system 110 records no dispute and no contrary event before expiry of the timeout, the smart contract system 110 may automatically release escrowed funds to the data provider node 102. The platform node 106A may reflect the auto-release by recording a completion status in off-chain logs and, where applicable, may rotate access keys for subsequent segments of a streaming dataset in the off-chain storage system 108 so that the data consumer node 112 continues to receive authorized portions.

Dispute handling may be initiated by a dispute trigger recorded to the smart contract system 110, which the platform node 106A may interpret as a request to pause settlement and to open a private communication channel. The platform node 106A may create an encrypted room in an anonymity-preserving chat service, associate pseudonymous participant identifiers for the data provider node 102 and the data consumer node 112, and grant access to a moderator account. A moderator using a dashboard may review only structured metadata and system logs that the platform node 106A exposes, without access to raw dataset contents or cryptographic material stored in the off-chain storage system 108. As an example, the data consumer node 112 may assert that a file header is inconsistent with the listed schema, the platform node 106A may place the escrow in a disputed state on the blockchain layer 410, and the moderator may review listing metadata, retrieval logs, and decryption status to propose a resolution.

Upon conclusion of dispute mediation, the platform node 106A may act based on a resolution reference recorded either by the smart contract system 110 or by the platform node 106A under governance rules. If the resolution favors release, the smart contract system 110 may settle escrow to the data provider node 102 and the platform node 106A may issue or restore an access credential for the off-chain storage system 108. If the resolution favors the data consumer node 112, the smart contract system 110 may refund escrowed funds and the platform node 106A may withhold or replace any previously issued access credential to prevent further retrieval. In a future configuration, the platform node 106A may also reference a decentralized arbitration service recorded on the blockchain layer 410, and the smart contract system 110 may condition final settlement on an arbitration outcome while the token layer 408 records the resulting transfer.

In one or more embodiments, the processor may bind the access-key payload to a license tier stored in either on- or off-chain state for the listing identifier, the license tier defining at least one of: permitted use categories, access duration, or volume limits, and wherein the access-key payload may be rendered invalid if a license violation state is recorded.

The platform node 106A may bind the access-key payload to a license tier stored either on-chain by reference in the smart contract system 110 or off-chain in association with the listing identifier, where the license tier defines one or more constraints that include permitted use categories, access duration, or volume limits. If a license violation state is recorded, the platform node 106A may render the access-key payload invalid so that the data consumer node 112 can no longer retrieve the dataset from the off-chain storage system 108. For example, a research-only license tier with a 30-day access duration and a daily download cap may be associated with the listing identifier on the smart contract system 110 and mirrored off-chain, and the platform node 106A may revoke the access-key payload upon detection of redistribution activity that breaches the permitted use category.

In one or more embodiments, the candidate dataset may be a streaming candidate dataset. In the case of streaming datasets, access authorization may differ from file-based datasets in that the buyer is granted time-bounded or entitlement-based access to a continuously updated data source rather than a static payload. Transaction state recorded on the blockchain (or platform node) represents an active or inactive access period, and continued access may be contingent upon the transaction remaining in an authorized state.

The candidate dataset may be a streaming candidate dataset sourced from equipment or systems that produce realtime updates, and the platform node 106A may coordinate issuance of successive access-key payloads to the data consumer node 112 based on platform-observed periodic settlement or usage states recorded by the smart contract system 110. The off-chain storage system 108 may expose the stream as rotating segments, and the platform node 106A may rotate keys or windows of access so that each segment is retrievable only during an authorized interval. As an example, a telemetry feed from the data provider node 102 may be divided into hourly segments, and the smart contract system 110 may record periodic usage states that cause the platform node 106A to emit a fresh access-key payload for each subsequent hour while expiring prior keys to maintain tiered, time-bounded access through the off-chain storage system 108.

In one or more embodiments, the processor may rotate a stream access key by emitting successive access-key payloads based on platform-observed periodic usage or settlement states from the smart contract for the listing identifier, thereby enabling access to time-segmented portions of the streaming candidate dataset. In streaming dataset embodiments, access credentials may be periodically rotated or refreshed to enforce continued authorization and to limit exposure in the event of credential compromise. Rotation of access credentials may occur automatically based on elapsed time, transaction state changes, or governance rules. Access credentials may be issued and managed by the platform node and are invalidated upon expiration, revocation, or termination of the associated transaction state.

The platform node 106A may rotate a stream access key by emitting successive access-key payloads based on periodic usage or settlement states recorded by the smart contract system 110 for a given listing identifier, thereby enabling time-bounded retrieval of distinct segments of a streaming candidate dataset from the off-chain storage system 108. Each access-key payload may be scoped to a corresponding time segment and may expire upon issuance of a subsequent payload, which maintains continuity for authorized users while preventing access outside approved intervals. For example, a streaming telemetry feed originating at the data provider node 102 may be divided into hourly segments, and the platform node 106A may issue a new access-key payload after the smart contract system 110 records a usage or settlement state for the preceding hour so that the data consumer node 112 can retrieve only the next authorized segment from the off-chain storage system 108.

In one or more embodiments, the candidate dataset may be secured at the off-chain storage node based on the access identifier for the off-chain storage node.

A dataset may be secured at the off-chain storage system 108 based on an access identifier that is generated or referenced by the platform node 106A and is required for retrieval by the data consumer node 112. The access identifier may bind an encrypted object or object family to access conditions that include time limits and license constraints, and the identifier may be conveyed within an access-key payload issued after applicable transaction states are recorded by the smart contract system 110. As an example, upon successful listing registration and subsequent purchase completion, the platform node 106A may return a time-limited access credential that embeds the access identifier so that the data consumer node 112 can fetch the encrypted dataset from the off-chain storage system 108 without exposing storage credentials or raw object locations.

In one or more embodiments, the method may further comprise: monitoring, at the processor, on-chain state recorded by the smart contract; and responsive to a detected purchase completion state, generating and transmitting the access-key payload for off-chain dataset retrieval, wherein the monitoring and transmission may be performed off-chain by the platform node processor without execution of application logic on the blockchain.

A processor of the platform node 106A may monitor on-chain state recorded by the smart contract system 110 and, responsive to detection of a purchase completion state for a listing identifier, may generate and transmit an access-key payload that authorizes off-chain dataset retrieval from the off-chain storage system 108. The monitoring and the transmission may be performed entirely off-chain by the platform node 106A without executing application logic on the blockchain, which preserves gas efficiency and maintains privacy boundaries while relying on on-chain state as an authoritative trigger. For example, the platform node 106A may detect a completion event emitted by the smart contract system 110, verify policy conditions, and deliver an access-key payload to the data consumer node 112 that enables retrieval of the purchased object from the off-chain storage system 108.

In one or more embodiments, the platform node may operate based on a governance state recorded on-chain, the governance state derived from token-weighted voting and defining at least one of: listing eligibility rules, fee parameters, dispute handling rules, or agent execution permissions.

The platform node 106A may operate based on a governance state recorded on-chain that is derived from token-weighted voting and that defines at least one of listing eligibility rules, fee parameters, dispute handling rules, or agent execution permissions. The governance state may be read by the platform node 106A as a set of effective parameters that constrain listing publication, pricing or fee application, dispute window handling, and the scope of actions permitted to provider or consumer agentic systems associated with the data provider node 102 and the data consumer node 112. As an example, a governance update recorded on the smart contract system 110 may set a minimum dataset quality threshold and adjust platform fee bands, after which the platform node 106A may apply those constraints during ranking, settlement orchestration, and verification of actions performed by authorized agents, while dataset payloads remain stored and delivered through the off-chain storage system 108.

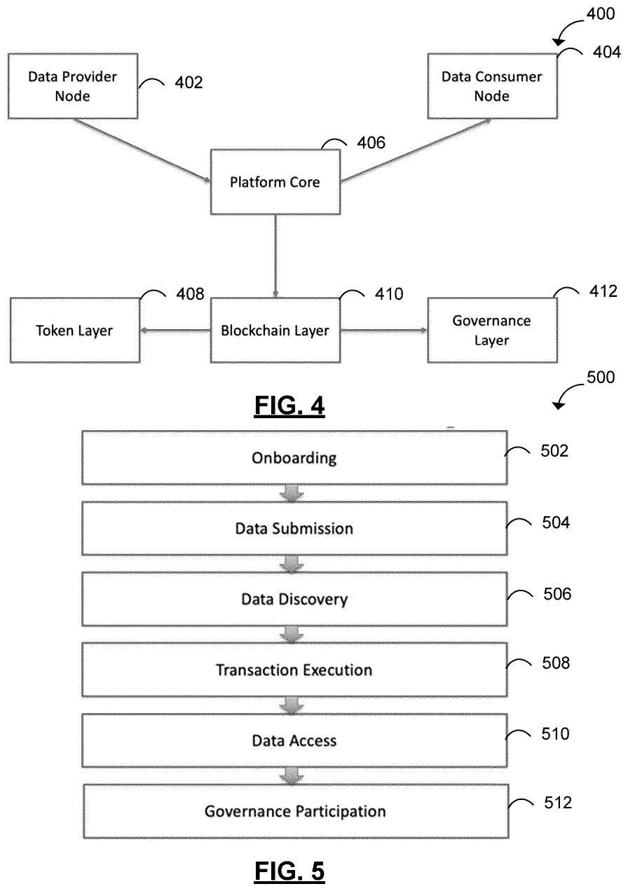

FIGS. 4-9 show various architecture diagrams for sharing a candidate dataset in accordance with one or more embodiments.

FIG. 4 shows a system architecture 400 with foundational layers that facilitate the privacy-preserving exchange of datasets between a data provider node 402 and a data consumer node 404. The architecture is composed of interconnected components, each serving a distinct role in ensuring secure, efficient, and compliant data transactions.

The data provider node 402 is responsible for preparing and submitting datasets along with associated metadata to the platform node 406. This node enables data-providing organizations to sanitize, encrypt, and upload datasets while maintaining privacy. The metadata submitted includes classification, coverage, and commercial attributes, which are used for listing and discovery purposes. The data provider node 402 interacts with the platform node 406 to register dataset listings and provide that raw datasets remain off-chain.

The data provider node 402 may be operated by a data-supplying organization and may prepare a candidate dataset together with associated metadata for submission to the platform node 406. The data provider node 402 may sanitize and encrypt the dataset, generate a listing identifier and an integrity reference, and cause storage of the encrypted payload in an off-chain repository referenced by other system components. The data provider node 402 may then send a dataset listing request comprising the metadata and integrity reference to the platform node 406 for registration and subsequent discovery. As an example, the data provider node 402 may upload a two-day time-series file for a manufacturing asset, produce classification and coverage descriptors, and transmit a listing request that allows the dataset to be cataloged while the encrypted payload remains protected off-chain.

The data consumer node 404 enables data-consuming organizations to search for, assess, and acquire datasets listed on the platform. This node communicates with the platform node 406 to query metadata, initiate purchases, and access datasets from off-chain storage. The data consumer node 404 functions within the framework of enterprise wallet governance, ensuring adherence to organizational policies and licensing requirements.

The data consumer node 404 may be operated by a data-consuming organization and may submit search queries to the platform node 406 in order to discover and evaluate listings using standardized metadata and quality indicators. Upon selection of a listing, the data consumer node 404 may initiate a purchase workflow and approve settlement under enterprise wallet controls, after which the data consumer node 404 may receive time-limited access instructions for retrieving the authorized dataset from off-chain storage. For example, the data consumer node 404 may search for centrifugal-pump telemetry with a minimum temporal density, commit tokenized funds to escrow, and then use issued access credentials to download the purchased segment from the referenced storage location.

The platform node 406 functions as the primary coordinator of the system. This component processes metadata and dataset payloads received from the data provider node 402, calculates dataset quality scores, and registers dataset listings through interactions with the blockchain layer 410. The platform node 406 also implements governance rules, manages licensing constraints, and facilitates dispute resolution. Furthermore, the design provides that raw datasets remain off-chain and are not accessible to the blockchain layer 410, thereby preserving privacy and scalability.

The platform node 406 may coordinate listing registration, discovery, transaction orchestration, and access control while maintaining privacy boundaries. The platform node 406 may validate incoming metadata from the data provider node 402, associate a listing identifier with integrity references, and interact with the blockchain layer 410 to record transaction state. The platform node 406 may also compute or store dataset quality scores and, upon detection of purchase completion, may issue time-limited access credentials for retrieval of the dataset by the data consumer node 404. As an example, the platform node 406 may receive a listing request, register the listing on the blockchain layer 410, and after settlement confirm completion and deliver an access-key payload that enables controlled download of the encrypted payload.

The token layer 408 facilitates financial transactions within the system. The token layer 408 manages tokenized payments, fee adjustments, and incentives. The token layer 408 interacts with the blockchain layer 410 to record transaction states and settlement events, ensuring tamper-resistant and auditable financial operations.

The token layer 408 may support programmable payments, fee adjustments, and incentive mechanisms that operate alongside marketplace transactions. The token layer 408 may be used during purchase to denominate consideration in a tokenized asset, apply fee parameters, and emit events that the platform node 406 correlates with listing and settlement states recorded on the blockchain layer 410. By way of example, the token layer 408 may process a purchase priced in a stablecoin, apply a platform fee encoded in basis points, and produce settlement events that the platform node 406 uses when deciding to release access instructions to the data consumer node 404.

The blockchain layer 410 provides a tamper-resistant ledger for recording transaction states, metadata references, and escrow conditions. This layer anchors the system's operations by ensuring transparency and immutability. The blockchain layer 410 does not store raw datasets but instead records cryptographic integrity references linking metadata to off-chain storage.

The blockchain layer 410 may provide a tamper-resistant ledger that records authoritative transaction state without storing raw dataset payloads. The blockchain layer 410 may store listing identifiers, escrow states, integrity references, and governance markers that the platform node 406 and other components consult to determine whether conditions for access, settlement, or dispute handling are met. For example, the blockchain layer 410 may record that a listing is active, that escrow is funded, and that a purchase completion state has occurred, which the platform node 406 may read to authorize issuance of an access-key payload to the data consumer node 404.

The governance layer 412 enforces platform policies and provides compliance with regulatory and operational requirements. The governance layer 412 defines and applies rules for licensing, dispute resolution, and transaction governance. The governance layer 412 interacts with the blockchain layer 410 to anchor governance decisions and policy states, ensuring that all actions are auditable and compliant.

The governance layer 412 may define and enforce policy across listing eligibility, fee parameters, dispute processes, and agent execution permissions, and the governance layer 412 may anchor effective rules to the blockchain layer 410 for auditability. The platform node 406 may evaluate actions by the data provider node 402 and the data consumer node 404 against the governance layer 412 so that only policy-compliant listings are published and only authorized agentic actions proceed. As an example, the governance layer 412 may establish a minimum dataset quality threshold and an escrow challenge duration that the platform node 406 applies during listing registration and settlement orchestration, while relying on the blockchain layer 410 to record the resulting governance state.

This architecture integrates decentralized and off-chain components to enable secure, privacy-preserving, and scalable data transactions. The separation of roles across the data provider node 402, data consumer node 404, platform node 406, token layer 408, blockchain layer 410, and governance layer 412 provides that sensitive data remains protected while enabling efficient marketplace operations.

FIG. 5 shows a method 500 illustrating the system processes involved in the privacy-preserving exchange of datasets within the disclosed platform. The flowchart outlines the sequential steps that participants, including data providers and data consumers, follow to interact with the system.

The onboarding process 502 involves the registration and verification of participants, including data providers and data consumers. This step provides compliance with regulatory requirements through privacy-preserving Know Your Customer (KYC) and Know Your Business (KYB) processes. Zero-knowledge proof (ZKP)-based attestations are used to verify identities without revealing sensitive information. Upon successful onboarding, participants are provisioned with enterprise wallets and pseudonymous identifiers for secure interactions within the platform.

Onboarding 502 may include registering an organization, performing privacy-preserving KYC or KYB checks through a regulated provider, and associating a pseudonymous marketplace identifier and enterprise wallet governance with the account. Onboarding 502 may also configure role-based permissions for operational and financial users so that subsequent listing, purchase, and access flows proceed under policy controls enforced by the platform node 406 and recorded as on-chain state in the blockchain layer 410 when applicable.

In the data submission step 504, data providers prepare and submit datasets along with associated metadata to the platform. The metadata includes classification, coverage, timestamp density, and commercial attributes, which are used for listing and discovery purposes. The datasets are encrypted and stored in off-chain storage 108 to provide privacy. The platform generates a listing identifier and an integrity reference linking the metadata to the dataset, which is then registered on the blockchain through a smart contract 110.

Data submission 504 may include the data provider node 402 preparing a candidate dataset and associated metadata, encrypting the dataset, and causing storage of the encrypted payload in an off-chain repository referenced by the platform node 406. During data submission 504, the data provider node 402 may transmit a dataset listing request comprising classification, coverage, and integrity references so that the listing can be registered by interaction between the platform node 406 and the blockchain layer 410 and discovered by other participants.

For example, in data submission 504 a provider may upload a 48-hour time-series CSV to off-chain storage, include metadata indicating a pump subsystem and one-second sampling, and submit a listing request that the platform node 406 uses to record a listing identifier and link the metadata to the stored payload.

In data discovery step 506, data consumers search for and evaluate datasets using the metadata registered on the blockchain. The platform's central functionality supports this process by providing standardized metadata and dataset quality scores derived from structural characteristics and metadata completeness. This step enables data consumers to assess the suitability of datasets for their needs without accessing raw data or revealing the identity of the data provider.

Data discovery 506 may enable the data consumer node 404 to query standardized metadata and view dataset quality indicators determined by the platform node 406 while raw payloads remain off-chain. The platform node 406 may, during data discovery 506, present ranked results that reflect attributes such as coverage, timestamp density, and composite quality scores to guide selection of listings that match consumer criteria.

As an example, in data discovery 506 a consumer may search for centrifugal pump datasets with at least one week of continuous sampling and a threshold quality score, after which the platform node 406 displays eligible listings without exposing the datasets stored off-chain.

At transaction execution step 508, once a data consumer selects a dataset, the transaction execution process begins. The consumer initiates a purchase by referencing the dataset listing identifier and committing settlement funds in tokenized stablecoin to a smart-contract-based escrow. The smart contract 110 enforces escrow conditions, ensuring that funds are securely held until the transaction is completed. The platform's central system monitors the transaction state and records updates on the blockchain.

Transaction execution 508 may include the data consumer node 404 initiating a purchase by referencing a listing identifier and causing escrow funding using tokenized consideration recorded by the blockchain layer 410. The smart contract state associated with transaction execution 508 may record transitions such as initiated, funded, challenged, and completed, which the platform node 406 monitors to coordinate downstream access authorization and fee handling.

For example, during transaction execution 508 a consumer may approve payment under enterprise wallet rules, the escrow state may be recorded on the blockchain layer 410, and the platform node 406 may wait for a completion state or for expiration of a challenge window before proceeding to access authorization.

At data access 510, upon confirmation of the transaction completion state by the smart contract 110, the platform's central component issues time-limited access credentials or signed download links to the data consumer. These credentials enable the consumer to retrieve the dataset from off-chain storage 108 securely. The system provides that raw datasets remain off-chain and inaccessible to the blockchain layer, preserving privacy and scalability.

Data access 510 may occur after the platform node 406 detects a purchase completion state on the blockchain layer 410 and may include issuing time-limited access credentials or an access-key payload that authorizes retrieval of the encrypted dataset from off-chain storage. Data access 510 may bind the issued credential to applicable license parameters so that retrieval by the data consumer node 404 complies with permitted use, duration, or volume limits.

As an example, in data access 510 the platform node 406 may generate a five-minute signed link or access-key payload for a purchased dataset and transmit it to the data consumer node 404, enabling a single authorized download while preserving privacy and leaving raw data off-chain.

At governance participation 512, participants (both data providers and data consumers) can engage in governance activities to influence platform policies and operations. The governance layer 412 enforces rules related to licensing, dispute resolution, and transaction governance. In future embodiments, token-based decentralized governance mechanisms may allow participants to vote on policy changes, fee structures, and other platform parameters. All governance actions are anchored on the blockchain for transparency and auditability.

Governance participation 512 may allow participants to engage in policy definition through token-weighted processes that produce a governance state anchored to the blockchain layer 410. The platform node 406 may consult the governance state during governance participation 512 to enforce rules that include listing eligibility, fee parameters, dispute handling procedures, and optional agent execution permissions.

For example, during governance participation 512 a token-based vote may adopt a minimum dataset quality threshold and a specific escrow challenge duration, after which the platform node 406 may apply these constraints to future listings and settlements recorded on the blockchain layer 410.

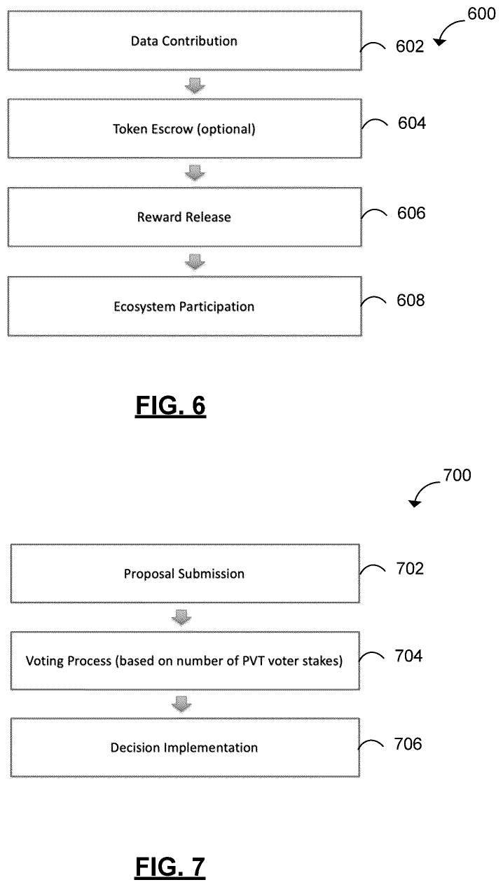

FIG. 6 shows a method diagram 600 illustrating the process of ecosystem participation within the disclosed platform, highlighting the sequential steps involved in contributing data, managing token-based incentives, and engaging with the ecosystem. The may include incentivizing participants to share datasets and purchase datasets using rewards.

The process begins with data contribution 602, where participants, such as data providers, submit datasets or metadata to the platform. This step involves preparing and uploading datasets, ensuring compliance with platform requirements, and associating metadata attributes such as classification, coverage, and timestamp density. The data contribution step 602 plays a significant role in facilitating discoverability and subsequent transactions within the ecosystem.

Data contribution 602 may include preparing a candidate dataset and associated metadata at the data provider node 402, performing optional sanitization or anonymization, and submitting the dataset descriptors to the platform node 406 together with an integrity reference that links the descriptors to an encrypted payload stored off-chain. Data contribution 602 may thereby supply classification, coverage, and structural indicators that the platform node 406 can later use for discovery and quality scoring while the raw dataset remains protected in the off-chain storage system 108.

By way of example, during data contribution 602 a provider may upload a two-day telemetry file for rotating equipment and include metadata indicating equipment type, sampling interval, and coverage period, enabling the platform node 406 to register the listing and associate it with an integrity reference to the off-chain object.

Following data contribution, an optional token escrow 604 step is implemented. In this step, tokenized stablecoins or platform-specific tokens are held in escrow to facilitate secure and conditional transactions. The escrow mechanism provides that rewards or payments are only released upon the fulfillment of predefined conditions, such as the successful validation of data quality or the completion of a purchase transaction. This step leverages blockchain-based smart contracts to enforce escrow conditions and maintain transparency.

Token escrow 604 may be initiated when a data consumer node 404 selects a listing and funds an escrow recorded by the smart contract system 110 using tokenized consideration represented in the token layer 408. Token escrow 604 may hold funds under predefined conditions, such as completion of delivery or expiration of a challenge period, and may emit state updates that the platform node 406 monitors to coordinate subsequent actions including access authorization and fee handling.

As an example, during token escrow 604 a consumer may commit stablecoin for a selected dataset, causing the smart contract system 110 to record a funded state referenced by the token layer 408, after which the platform node 406 may await either explicit confirmation of delivery or the close of a dispute window before proceeding.

Once the escrow conditions are satisfied, the reward release 606 step occurs. In this step, tokens or other incentives are distributed to participants based on their contributions or actions within the ecosystem. For example, data providers may receive rewards for submitting high-quality datasets, while data consumers may earn incentives for engaging in governance activities or completing transactions. The reward release mechanism 606 is designed to encourage active participation and provide fair compensation.

Reward release 606 may occur after the conditions attached to token escrow 604 are satisfied, at which point the smart contract system 110 may authorize settlement to the provider wallet and the platform node 406 may facilitate distribution of any incentive or fee adjustments defined by the token layer 408. Reward release 606 may therefore finalize economic flows associated with the listing identifier while preserving auditability through recorded on-chain state and corresponding off-chain logs.

For example, following successful verification of delivery, reward release 606 may cause escrowed funds to transfer to the data provider node 402 and any applicable platform incentives to be applied, after which the platform node 406 may update purchase records and enable the buyer to proceed to controlled access operations.

The final step, ecosystem participation 608, encompasses the broader engagement of participants within the platform. This includes activities such as governance voting, dispute resolution, and further data transactions. Participants can leverage their rewards or tokens to influence platform policies, access additional datasets, or contribute to the overall growth of the ecosystem. This step 608 provides a dynamic and collaborative environment that supports the platform's scalability and sustainability.

Ecosystem participation 608 may encompass ongoing activities enabled by the platform, such as listing more datasets, redeeming or applying tokenized incentives, and engaging in governance processes that set marketplace rules read by the platform node 406. Ecosystem participation 608 may rely on accumulated signals and token events recorded on the blockchain layer 410, allowing participants to influence policy while continuing to transact through standardized listing and access workflows.

As an example, during ecosystem participation 608 a provider that has completed several sales may use earned platform tokens to offset future fees or to participate in token-weighted voting that updates eligibility thresholds enforced by the platform node 406 for subsequent listings.

FIG. 7 shows a flowchart of a decision-making process within a governance framework that leverages token-based voting mechanisms. This process provides that decisions are made transparently and in alignment with the collective interests of stakeholders, as determined by their token stakes.

In step 702, a proposal submission is initiated. This step involves the creation and submission of a proposal by a participant or group of participants within the system. The proposal may pertain to platform policies, operational changes, or other governance-related matters. The submission process provides that the proposal is formally registered and made available for review by eligible voters.

Proposal submission 702 may comprise preparation and registration of a governance proposal by an authorized participant or agentic process, including a proposed change to one or more platform parameters and associated rationale, scope, and timing. During proposal submission 702, the platform node 406 may validate proposer eligibility against a governance state maintained by the governance layer 412 and anchored on the blockchain layer 410, and may assign a proposal identifier, a voting window, and any quorum or threshold values required for subsequent evaluation. As an example, proposal submission 702 may register a proposal to update a minimum dataset quality threshold and to adjust fee bands, with the platform node 406 recording references on the blockchain layer 410 so that downstream voting and auditability are preserved under the governance layer 412.

In step 704, a voting process is conducted. This step involves the evaluation of the submitted proposal by stakeholders who hold loyalty tokens (PVT herein). The voting process is weighted based on the number of PVT tokens staked by each voter, ensuring that participants with a higher stake in the system have a proportionally greater influence on the decision. The voting mechanism may include features such as quorum requirements, minimum participation thresholds, and time-bound voting windows to provide fairness and compliance with governance rules.

The voting process 704 may allow eligible stakeholders to cast token-weighted votes within a defined window, with weighting determined by balances recognized by the governance layer 412 and state recorded on the blockchain layer 410. The platform node 406 may tally ballots for the voting process 704 subject to governance rules that may include quorum, minimum participation thresholds, or category-specific permissions, and may publish an interim or final result for later enforcement. By way of example, under the voting process 704 holders of a governance token may cast votes for or against a proposal to modify the escrow challenge period, where the platform node 406 records vote receipts on the blockchain layer 410 and the governance layer 412 evaluates whether quorum and threshold conditions are satisfied.

In step 706, the decision implementation occurs. Once the voting process concludes and the results are validated, the decision is implemented in accordance with the outcome. This step may involve updating platform policies, executing smart contract changes, or initiating other actions as specified in the approved proposal. The implementation process is designed to be auditable and transparent, with the results anchored on the blockchain to provide accountability and immutability.

Decision implementation 706 may occur after validation of the voting outcome and may include updating the effective governance state used by the platform node 406 to enforce listing eligibility rules, fee parameters, dispute handling rules, or agent execution permissions. The updated governance state for decision implementation 706 may be persisted on the blockchain layer 410 for auditability while corresponding configuration used by the platform node 406 is applied off-chain to operational workflows. For example, following approval of a proposal that sets a new minimum quality score and revises platform fee percentages, decision implementation 706 may cause the platform node 406 to reject listings below the threshold and to apply the updated fees at settlement, with the governance layer 412 exposing the adopted parameters through on-chain references.

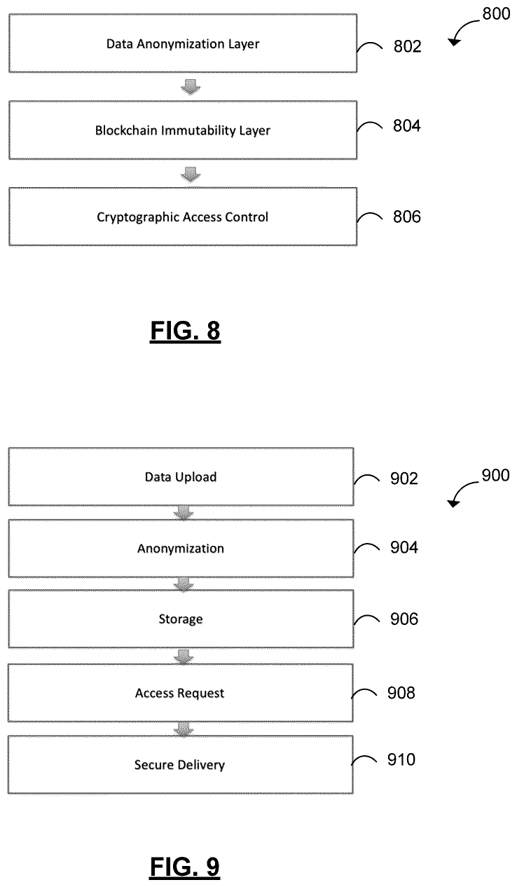

FIG. 8 shows a layered system architecture 800 that integrates multiple components to provide secure, privacy-preserving, and efficient data exchange within a decentralized platform. The architecture is composed of three distinct layers, each serving a specific role in the system's functionality.

The data anonymization layer 802 is responsible for ensuring the privacy of sensitive information by applying anonymization techniques to datasets before they are shared or processed. This layer employs methods such as k-anonymity, I-diversity, and t-closeness to remove or obfuscate identifiable information while preserving the utility of the data. By doing so, the anonymization layer 802 prevents the re-identification of data sources and provides compliance with privacy regulations. The anonymization layer 802 operates at the data provider node 102, where raw datasets are sanitized prior to submission to the platform, ensuring that no sensitive information is exposed during subsequent operations.

The data anonymization layer 802 may apply privacy techniques to remove or obfuscate identifying attributes from a candidate dataset before submission, including methods that reduce re-identification risk while retaining analytical utility. The data anonymization layer 802 may operate at the data provider node to sanitize raw records prior to processing by the platform node 406 or storage in the off-chain storage system 108, thereby supporting privacy, regulatory compliance, and downstream scoring or discovery without exposing sensitive content. For example, the data anonymization layer 802 may generalize quasi-identifiers, suppress outliers, and normalize units on a manufacturing telemetry file so that the platform node 406 can compute quality indicators and register a listing without handling raw, linkable signals.

In some configurations, the data anonymization layer 802 may be combined with metadata generation so that classification, coverage, and timestamp density descriptors are derived from the sanitized view. The data anonymization layer 802 may therefore provide consistent inputs for ranking or pricing guidance while protecting the original dataset that remains encrypted off-chain. As an example, the data anonymization layer 802 may output only schema headers, sampling statistics, and range summaries to enable standardized scoring routines without leaving residuals that could reconstruct the underlying records.

The blockchain immutability layer 804 provides a tamper-resistant ledger for recording transaction states, metadata references, and escrow conditions. This layer provides that all operations, including dataset listings, purchases, and governance actions, are transparently and immutably recorded. The blockchain immutability layer 804 also anchors governance decisions and policy states, enabling auditable and compliant operations. Furthermore, the blockchain immutability layer 804 interacts with smart contracts 110 to enforce escrow conditions and manage settlement processes.

The blockchain immutability layer 804 may serve as a tamper-resistant ledger that records dataset listing identifiers, integrity references, escrow states, and governance markers, while excluding raw dataset payloads. The blockchain immutability layer 804 may anchor transaction states emitted by the smart contract system 110, which the platform node 406 can read to coordinate listing publication, settlement, and dispute handling, without requiring application logic or data storage on the chain beyond the recorded state and references. For example, the blockchain immutability layer 804 may store a listing identifier, a cryptographic integrity reference, and a purchase completion flag that enable the platform node 406 to authorize off-chain access to the corresponding encrypted object.

In certain implementations, the blockchain immutability layer 804 may also record governance outcomes that define fee parameters, listing eligibility thresholds, or dispute windows, allowing the platform node 406 to enforce policy consistently across participants. As an example, after a token-weighted vote updates an eligibility rule, the blockchain immutability layer 804 may expose the adopted parameter so that the platform node 406 rejects listings that do not meet the threshold while continuing to deliver purchased datasets through off-chain mechanisms.

The cryptographic access control layer 806 secures access to off-chain datasets by employing cryptographic mechanisms. This layer generates and manages access credentials, such as time-limited access codes or signed download links, which are issued to authorized data consumers upon transaction completion. These credentials are cryptographically bound to the transaction state recorded on the blockchain, ensuring that only authorized users can retrieve the datasets. This layer also enforces licensing constraints, such as usage limits and access durations, by invalidating access credentials upon detecting violations.

The cryptographic access control 806 may secure retrieval of encrypted datasets stored in the off-chain storage system 108 by requiring possession of a valid access credential or access-key payload issued by the platform node 406 upon detection of an on-chain completion state. The cryptographic access control 806 may implement time-limited credentials, scoped permissions, and revocation conditions that bind access to license parameters, thereby preventing unauthorized download or reuse of credentials outside the defined window. For example, the cryptographic access control 806 may use a signed, short-duration link or token tied to a license tier so that the data consumer node 404 can fetch the authorized object without exposing storage secrets or raw locations.

In streaming scenarios, the cryptographic access control 806 may rotate credentials across time-segmented portions of a feed so that each segment is accessible only while the corresponding credential remains valid, with issuance triggered by usage or settlement states read from the chain. As an example, the cryptographic access control 806 may provide a sequence of hourly access-key payloads that allow retrieval of successive segments from the off-chain storage system 108, expiring each prior key to limit access to the authorized interval.

FIG. 9 shows a flowchart illustrating the sequential steps involved in the processing and secure exchange of datasets within the disclosed system. The flowchart highlights the integration of privacy-preserving mechanisms and secure delivery protocols to provide the confidentiality and integrity of the datasets throughout their lifecycle.

In step 902, data upload is initiated by a data provider node 102. The data provider node 102 prepares the dataset and submits the dataset to the platform node 106A. This step involves the inclusion of metadata, such as classification, coverage, and commercial attributes, which are necessary for listing and discovery purposes. The dataset is transmitted securely to prevent unauthorized access during the upload process.

Data upload 902 may include preparing a candidate dataset at the data provider node 102 together with associated metadata and transmitting the dataset to the platform node 106A for registration and linkage to off-chain storage 108. During data upload 902, the data provider node 102 may also supply an integrity reference that associates the metadata with the corresponding encrypted payload, enabling the platform node 106A to register a listing identifier on the smart contract system 110 without exposing raw values. For example, in data upload 902 a manufacturer may transmit a two-day time-series file for a pump subsystem to the platform node 106A along with classification, coverage, and timestamp descriptors, allowing the platform node 106A to proceed with listing while the encrypted object is referenced for later retrieval.

In step 904, anonymization is performed on the dataset. This step provides that sensitive information is obfuscated or removed to prevent the re-identification of data sources. Techniques such as k-anonymity, I-diversity, and t-closeness may be applied to achieve compliance with privacy regulations. The anonymization process is executed at the data provider node 102, ensuring that raw datasets are sanitized before submission to the platform node 106A.

Anonymization 904 may be performed on the dataset prior to or as part of submission so that sensitive identifiers are removed or generalized while preserving analytical utility for discovery and scoring. Anonymization 904 may occur at the data provider node 102 and may feed standardized descriptors to the platform node 106A without transferring identifiable content, thereby supporting privacy and regulatory requirements while enabling downstream processing. As an example, in anonymization 904 a provider may generalize facility identifiers, normalize units, and suppress rare quasi-identifiers in a telemetry file so that the platform node 106A can compute quality indicators and register a listing that references the off-chain storage 108 through an integrity link and on-chain state recorded by the smart contract system 110.

In step 906, the dataset is securely stored in an off-chain storage system 108. The off-chain storage system 108 encrypts the dataset and generates an access identifier to provide that only authorized users can retrieve the data. This step separates the raw dataset from the blockchain layer 410, maintaining privacy and scalability while ensuring the integrity of the stored data.

Storage 906 may comprise securing the dataset in the off-chain storage system 108 using encryption and an access identifier that controls retrieval by authorized parties. In storage 906, the platform node 106A may associate the access identifier with the listing identifier recorded on the smart contract system 110, permitting later issuance of time-limited credentials without placing raw payloads on the blockchain layer 410. For example, during storage 906 the encrypted dataset may be written to a private object store under off-chain storage 108, and the platform node 106A may persist an integrity reference and access identifier that allow the data consumer node 112 to retrieve the object only after purchase completion.

In step 908, an access request is initiated by a data consumer node 112. The data consumer node 112 queries the platform node 106A for available datasets and selects a dataset of interest. Upon initiating a purchase, the platform node 106A verifies the transaction state recorded on the blockchain layer 410 and provides compliance with licensing and governance rules. The access request is processed securely to maintain the anonymity of both the data provider node 102 and the data consumer node 112.

Access request 908 may be initiated by the data consumer node 112 after discovery and selection of a listing, and may include a request to the platform node 106A to authorize retrieval based on on-chain transaction state. In access request 908, the platform node 106A may consult the smart contract system 110 to verify that settlement conditions are met and that any challenge window has expired or been resolved, and then prepare the parameters required to generate access credentials for the off-chain storage system 108. As an example, during access request 908 the data consumer node 112 may reference a listing identifier and licensing tier, prompting the platform node 106A to confirm a completion state on the smart contract system 110 and to proceed with controlled issuance of a short-lived access token.

In step 910, secure delivery of the dataset is facilitated. The platform node 106A generates time-limited access credentials or signed download links, which are issued to the data consumer node 112. These credentials enable the data consumer node 112 to retrieve the dataset from the off-chain storage system 108 securely. The delivery process provides that raw datasets remain off-chain and inaccessible to the blockchain layer 410, preserving privacy and scalability.

Secure delivery 910 may include the platform node 106A generating and transmitting an access-key payload or time-limited credential that enables the data consumer node 112 to retrieve the purchased dataset from the off-chain storage system 108 while maintaining privacy boundaries. In secure delivery 910, the platform node 106A may bind the credential to license parameters, including duration or volume limits, and may invalidate the credential if a violation state is detected, while relying on the smart contract system 110 as the authoritative source for completion and dispute resolution states. For example, during secure delivery 910 the platform node 106A may issue a five-minute signed URL or equivalent access-key payload to the data consumer node 112 immediately after detecting a purchase completion event for the listing identifier, thereby enabling a single authorized download from the off-chain storage system 108.

FIGS. 10-17 show various user interface diagrams for sharing a candidate dataset in accordance with one or more embodiments.

FIG. 10 shows a user interface of a marketplace 1000 designed for the secure and privacy-preserving exchange of datasets. The interface provides various interactive elements and displays relevant information to facilitate dataset transactions between data providers and consumers.

The listed datasets 1002 are prominently displayed in the main section of the interface, for example, in response to a search using search control 1004. Each dataset entry includes detailed information, such as the dataset name, metadata, and associated attributes. For example, the dataset entry 1002A corresponds to the “BoilerTech Boiler-X boiler system” dataset, which is categorized under manufacturing, electronics, and industrial automation. This entry provides a clear and concise overview of the dataset's domain and purpose.

The dataset score 1002B is displayed alongside the dataset entry, providing a quality assessment based on metadata completeness, structural characteristics, and other scoring parameters. This score enables potential buyers to evaluate the dataset's quality and suitability for their needs without accessing the raw data. Additionally, the dataset price 1002C is shown, indicating the cost of the dataset in USDC, which is the tokenized stablecoin used for transactions on the platform.

A search control 1004 is provided at the top of the interface, allowing users to search for datasets using keywords or filters. This feature enhances discoverability and enables users to quickly locate datasets that match their specific requirements.

The interface includes a “Sell dataset” button 1006, which allows data providers to initiate the process of listing their datasets on the marketplace. This button provides a streamlined entry point for dataset submission and metadata registration.

The token balance 1008 is displayed in the lower-left section of the interface, showing the user's current balance of loyalty tokens (PVT). These tokens can be used for transactions, fee adjustments, and other platform activities. Below the token balance, the wallet 1010 is shown, providing access to the user's enterprise wallet for managing funds and approving transactions.

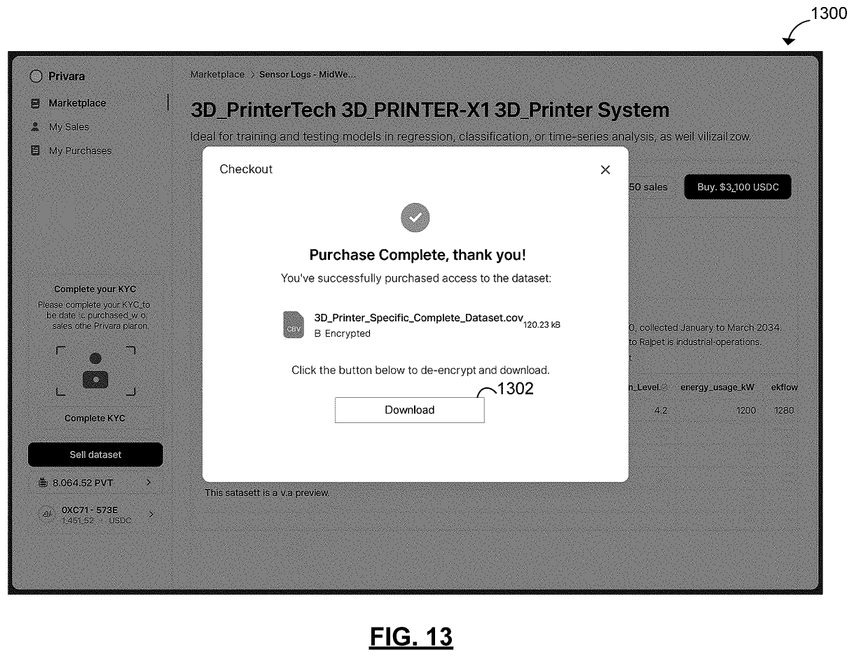

FIG. 11 shows a user interface 1100 for a dataset listing within a privacy-preserving data marketplace. The interface is designed to facilitate the discovery, evaluation, and purchase of datasets by potential buyers while maintaining a user-friendly and privacy-compliant experience.

The dataset name 1104 is prominently displayed at the top of the interface, providing a clear and concise identifier for the dataset. In this example, the dataset is titled “3D_PrinterTech 3D_PRINTER-X1 3D_Printer System,” indicating the inclusion of operational logs from a 3D printer system. This name assists users in efficiently determining the dataset's relevance to their requirements.

Below the dataset name, the dataset description 1106 provides detailed information about the dataset's contents and purpose. The description specifies that the dataset includes operational logs collected over a 48-hour period from a 3D printer system model 3D_printer-X1. The description also outlines the captured metrics, including temperature, mechanical performance, usage, and efficiency indicators. This comprehensive explanation allows potential buyers to evaluate the dataset's appropriateness for their intended applications, such as regression analysis, classification, or time-series analysis.

The interface also includes a buy dataset button 1102, which allows users to initiate the purchase of the dataset. The button displays the price of the dataset in USDC, the tokenized stablecoin used for transactions on the platform. This feature streamlines the purchasing process, enabling users to acquire datasets with a single click.

Additional elements of the interface, such as dataset quality scores, user reviews, and transaction statistics, may be displayed to provide further insights into the dataset's value and reliability.

FIG. 12 shows a user interface 1200 for facilitating the purchase of a dataset within a privacy-preserving data marketplace. The interface is designed to provide users with a clear and intuitive process for reviewing and confirming their dataset purchase, ensuring transparency and compliance with platform policies.

The primary component of the interface is a checkout dialog that displays significant purchase details. The dataset price 1202 is prominently shown, indicating the cost of the dataset in USDC (a tokenized stablecoin). This price is accompanied by a reward notification, which specifies the amount of Tokens (PVT) the buyer will earn upon completing the purchase. This reward encourages transactions and fosters engagement within the platform.

Below the dataset price 1202, the purchase subtotal 1204 is detailed. This section itemizes the transaction, including the dataset price 1202, a transaction fee (calculated as a percentage of the dataset price 1202), and any applicable discounts. For example, users may opt to use PVT to receive a discount on the transaction fee, as indicated by the checkbox option. The total amount payable is calculated and displayed, ensuring the buyer has full visibility into the financial breakdown of the transaction.

The interface also includes a sign-on wallet button 1206, which allows the user to authenticate and approve the transaction using their enterprise wallet. This step provides secure and compliant payment processing, leveraging the platform's wallet governance mechanisms. The wallet integration supports tokenized payments and enforces organizational policies, such as multi-approver workflows or spending limits.

The surrounding interface provides additional context, including the dataset name, description, and metadata, enabling the buyer to verify the dataset's relevance and quality before proceeding with the purchase. The left-hand panel includes options for completing KYC (Know Your Customer) verification, managing token balances, and accessing other marketplace features, ensuring a seamless and privacy-preserving user experience.

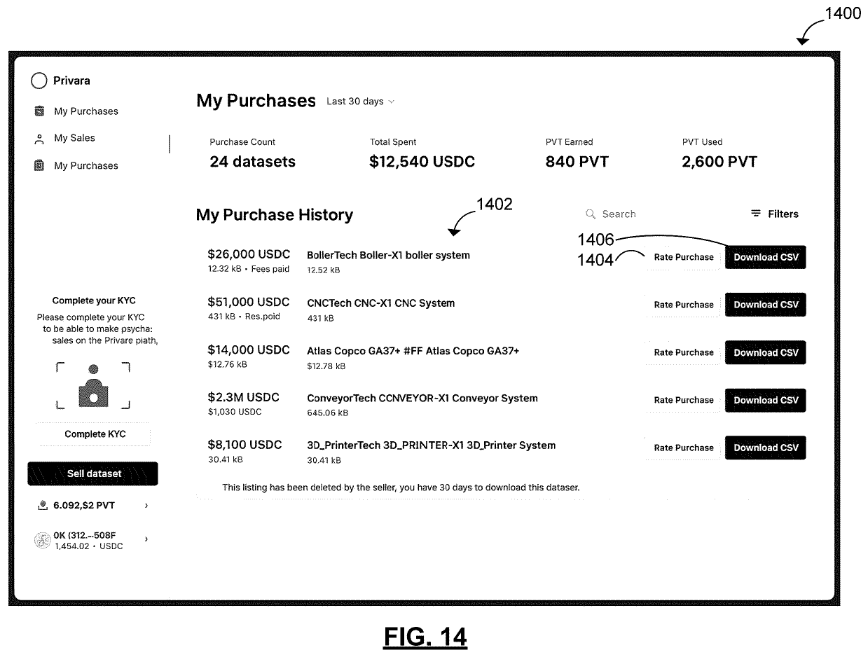

FIG. 13 shows a user interface 1300 for completing the purchase and initiating the download of a dataset within a privacy-preserving data marketplace. The interface is designed to provide users with a seamless and secure mechanism for accessing datasets after a successful transaction.

The primary element of the interface is a confirmation dialog that appears after the purchase process concludes. This dialog includes a noticeable success message, “Purchase Complete, thank you!” which verifies that the user has completed the acquisition of access to the dataset. Below this message, the interface presents the name of the acquired dataset, “3D_Printer_Specific_Complete_Dataset.csv,” along with the file size and a notification indicating encryption of the dataset.

The dataset download button 1302 is prominently displayed within the confirmation dialog. This button allows the user to initiate the decryption and download process for the purchased dataset. Upon clicking the button, the system decrypts the dataset and provides the user with a secure download link. This provides that only authorized users who have completed the purchase can access the dataset, maintaining the privacy and security of the transaction.

The interface also includes contextual information about the dataset, such as the description and intended use cases, which are visible in the background. This information assists the user in verifying the relevance of the dataset to their needs. Furthermore, the left-hand panel of the interface offers access to additional marketplace features, including completing KYC (Know Your Customer) verification, managing token balances, and listing datasets for sale.

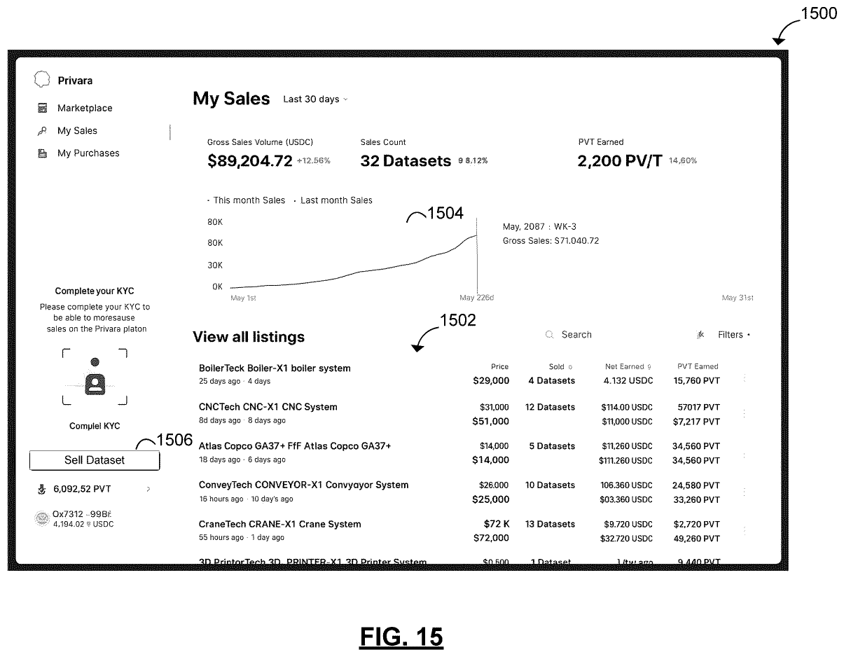

FIG. 14 shows a user interface 1400 for managing purchase history within a privacy-preserving data marketplace. This interface provides users with a comprehensive view of their past dataset transactions, enabling efficient management of purchased datasets and associated actions.

The interface includes a purchase summary section at the top, which displays aggregated metrics such as the total number of datasets purchased, the total amount spent in USDC, the Tokens (PVT) earned, and the PVT used. These metrics provide users with a quick overview of their transaction activity over a specified time period, such as the last 30 days.

Below the summary section, the purchase history table lists individual dataset transactions. Each row in the table corresponds to a purchased dataset and includes the following details:

Purchased dataset listing 1402: This column displays the name of the dataset, along with additional metadata such as the purchase price in USDC, the file size, and any associated fees. For example, the dataset “BoilerTech Boiler-X1 boiler system” is listed with a price of $26,000 USDC and a file size of 12.32 KB.

Rate dataset button 1406: This button allows users to provide feedback or rate their experience with the purchased dataset. This feature supports the platform's quality assurance and governance mechanisms by enabling users to contribute to the dataset's reputation and scoring.

Download dataset button 1404: This button provides users with the ability to securely download the purchased dataset in CSV format. The system provides that only authorized users can access the dataset by verifying purchase completion and issuing time-limited access credentials.

The interface also includes search and filter controls to help users locate specific datasets within their purchase history. These controls enhance usability by allowing users to refine the displayed results based on criteria such as dataset name, purchase date, or price.

On the left-hand side, the interface features a navigation panel that provides access to other sections of the platform, such as “My Purchases,” “My Sales,” and “Sell Dataset.” Additionally, a KYC completion prompt is displayed, reminding users to complete their Know Your Customer (KYC) verification to enable full platform functionality.

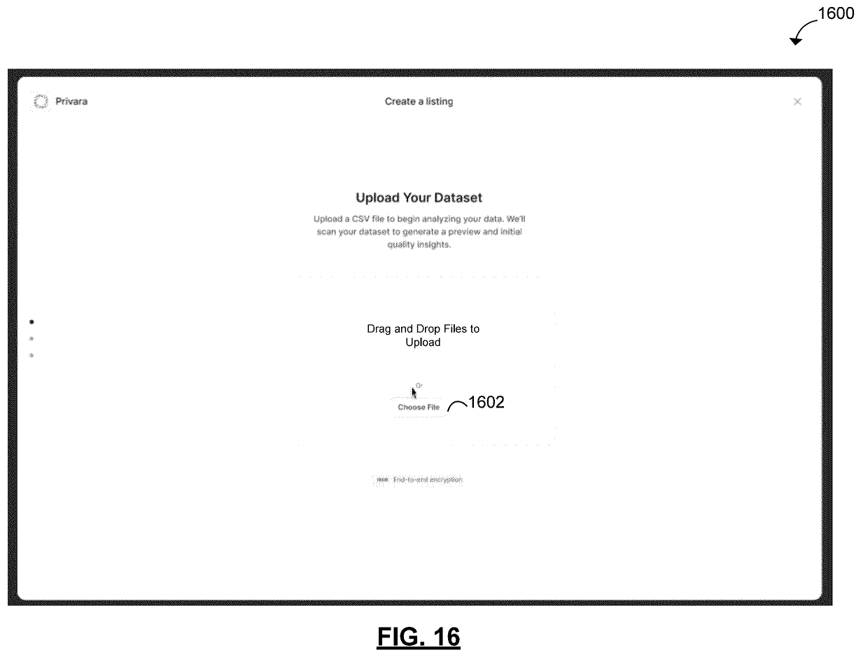

FIG. 15 shows a sales dashboard interface 1500 designed to provide data providers with a comprehensive overview of their dataset sales performance within the platform. The interface integrates significant metrics, visualizations, and actionable controls to facilitate efficient sales management and decision-making.

The sales graph 1504 is prominently displayed in the upper section of the interface, providing a visual representation of sales trends over a specified time period, such as the last 30 days. The graph illustrates gross sales volume in USDC, enabling users to track fluctuations and identify patterns in their sales performance. The graph also includes comparative data, such as sales from the previous month, to highlight growth or decline trends.

Below the sales graph, the dataset sales listing 1502 presents a detailed table of all datasets listed by the data provider. Each row in the table corresponds to a specific dataset and includes attributes such as the dataset name, price, number of datasets sold, total earnings in USDC, and loyalty Tokens (PVT) earned. This tabular format allows users to efficiently assess the performance of individual datasets and identify listings with varying levels of success. The table also includes search and filter controls, enabling users to refine the displayed results based on specific criteria, such as dataset name, sales volume, or date of listing.

The sell dataset button 1506 is located in the lower-left section of the interface, providing a direct and intuitive mechanism for data providers to initiate the process of listing new datasets on the platform. This button streamlines the dataset submission workflow, allowing users to upload datasets, define metadata, and set pricing parameters with minimal effort.

The interface also includes additional contextual information, such as the total gross sales volume, total sales count, and total loyalty tokens (PVT) earned, displayed at the top of the dashboard. These aggregated metrics provide users with a high-level summary of their overall sales performance. The inclusion of percentage changes compared to previous periods further enhances the user's ability to monitor progress and make informed decisions.

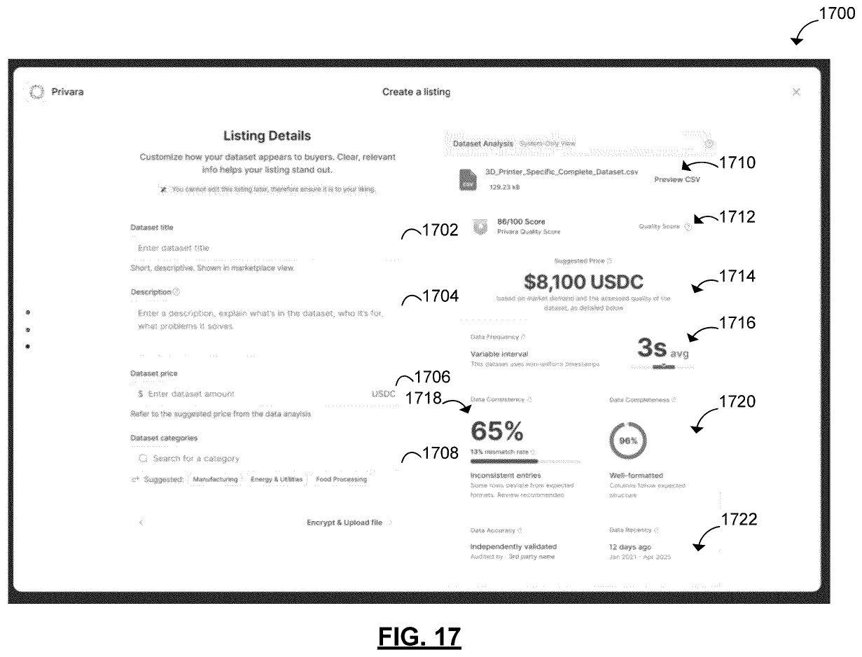

FIG. 16 shows a user interface screen 1600 for uploading a dataset within a privacy-preserving data marketplace. This interface is designed to facilitate the seamless submission of datasets by data providers while ensuring compliance with platform requirements and maintaining data security.

The central feature of the interface is an upload dataset button 1602, which provides users with the ability to select and upload files directly from their local storage. The button 1602 is prominently displayed within a drag-and-drop area, allowing users to either click the button 1602 to browse for files or drag files into the designated area for upload. This dual functionality enhances usability and accommodates different user preferences.

The interface includes a clear instruction section above the upload area, guiding users to upload datasets in a supported format, such as CSV. The instructions also inform users that the platform will scan the uploaded dataset to generate a preview and initial quality insights. This feature provides that users are aware of the subsequent steps in the dataset submission process, including metadata generation and quality scoring.

FIG. 17 shows a user interface 1700 for creating a dataset listing within a privacy-preserving data marketplace. The interface is designed to guide data providers through the process of listing their datasets by providing fields for metadata input, pricing suggestions, and quality analysis metrics. The interface provides that the dataset listing is comprehensive, discoverable, and aligned with marketplace standards.

The left section of the interface provides input fields for defining the dataset's primary characteristics:

Dataset title 1702: This field allows the user to specify a concise and descriptive title for the dataset. The title is prominently displayed in the marketplace to attract potential buyers.

Dataset description 1704: This field enables the user to provide a detailed explanation of the dataset's contents, the intended use cases of the dataset, and the problems addressed by the dataset. This description helps buyers evaluate the dataset's relevance to their needs.

Dataset price 1706: The user can manually set the price of the dataset in USDC. The interface also references a suggested price 1714 derived from the dataset analysis to assist the user in pricing decisions.

Dataset categories 1708: This dropdown menu allows the user to select one or more categories that most appropriately describe the dataset. Categories such as “Manufacturing,” “Energy & Utilities,” and “Food Processing” are available to enhance discoverability.

The right section of the interface provides an analysis of the dataset's quality and metadata completeness:

Dataset analysis 1710: This section displays a summary of the dataset's analysis, including a preview of the dataset file (e.g., “3D_Printer_Specific_Complete_Dataset.csv”) and the metadata linked to the dataset.

Dataset score 1712: A quality score is prominently displayed, providing an overall assessment of the dataset's quality based on various metrics. This score helps buyers quickly evaluate the dataset's reliability and value.

Suggested price 1714: Based on the dataset's quality score and market trends, the interface suggests a price for the dataset. This feature assists the user in setting a competitive and fair price.

Data frequency metric 1716: This metric evaluates the regularity of data sampling intervals, providing insights into the dataset's temporal density. For example, the interface may display an average interval of “3s” between data points.

Data consistency metric 1718: This metric assesses the consistency of the dataset's entries, highlighting any anomalies or inconsistencies. For instance, the interface may indicate that “65% of entries are inconsistent.”

Data completeness metric 1720: This metric measures the percentage of required fields that are populated with valid data. A high completeness score, such as “96%,” indicates that the dataset is well-structured and comprehensive.

Data recency metric 1722: This metric evaluates the dataset's timeliness by indicating how recently the data was validated or updated. For example, the interface may display “12 days ago” as the last validation date.

The embodiments described above are intended to be exemplary only. The scope of the invention is therefore intended to be limited solely by the claims appended.

1. A computer-implemented method for sharing a candidate dataset at a data provider node, comprising:
receiving, at a processor of the data provider node, the candidate dataset and metadata associated with the candidate dataset;
sending, from the processor to an off-chain storage node, the dataset secured at the off-chain storage node based on an access identifier for the off-chain storage node;
generating, at the processor, a listing identifier and an integrity reference linking the metadata to the dataset in the off-chain storage node;
sending, from the processor to a platform node, a dataset listing request comprising the listing identifier, the metadata and the integrity reference linking the metadata to the dataset in the off-chain storage node; and
receiving, at the processor based on the dataset listing request, a dataset listing response comprising a confirmation from the platform node that the dataset has been registered and stored,
wherein when the processor receives a recorded purchase state associated with the listing identifier from a smart contract, emitting to a buyer wallet address an access-key payload comprising the access identifier that is usable by a consumer node associated with the buyer wallet address to access the dataset at the off-chain storage node.

2. The method of claim 1 wherein the dataset listing request further comprises the metadata, the integrity reference to the location of the dataset at the off-chain storage node, wherein the metadata used by the platform node to generate a dataset quality score for comparative ranking and pricing of the dataset without revealing an identity of the data provider node, the data consumer node, and the platform node.

3. The method of claim 2, further comprising:
determining, at the processor, classification metadata for the candidate dataset;
determining, at the processor, coverage metadata for the candidate dataset;
determining, at the processor, timestamp density metadata of the candidate dataset;
determining, at the processor, commercial metadata for the candidate dataset; and
determining, at the processor, field consistency metadata of the candidate dataset based on a predetermined plurality of fields,
wherein the metadata comprises the classification metadata, the coverage metadata, the timestamp density metadata, the commercial metadata and the field consistency metadata, and
wherein the dataset listing request further comprises an ephemeral copy of the dataset, and the platform node generates the dataset quality score based on the ephemeral copy of the dataset.

4. The method of claim 1 wherein the generating of the dataset, sending the dataset, and the sending the dataset listing request are performed by a provider agentic system at the data provider node.

5. The method of claim 4, wherein the provider agentic system negotiates with a consumer agentic system to thereby perform at least one selected from the group of: generate the recorded purchase state, request clarification metadata, and propose modified commercial parameters subject to at least one constraint defined by organizational policy or governance state.

6. The method of claim 5 wherein the dataset listing request is received by a platform agentic system at the platform node node.

7. The method of claim 1, wherein, prior to emitting the access-key payload, the smart contract enforces an escrow challenge window and, upon detection of a dispute event recorded on-chain during the challenge window, withholds or replaces the access-key payload until a resolution state is recorded by at least one selected from the group of: the smart contract and the platform node.

8. The method of claim 1, wherein the processor binds the access-key payload to a license tier stored in either on- or off-chain state for the listing identifier, the license tier defining at least one of: permitted use categories, access duration, or volume limits, and wherein the access-key payload is rendered invalid if a license violation state is recorded.

9. The method of claim 1 wherein the candidate dataset is a streaming candidate dataset.

10. The method of claim 9 wherein the processor rotates a stream access key by emitting successive access-key payloads upon recording periodic usage or settlement states from the smart contract for the listing identifier, thereby enabling access to time-segmented portions of the streaming candidate dataset.

11. The method of claim 1, further comprising:
monitoring, at the processor, on-chain state recorded by the smart contract; and
responsive to a detected purchase completion state, generating and transmitting the access-key payload for off-chain dataset retrieval,
wherein the monitoring and transmission are performed off-chain by the platform node processor without execution of application logic on the blockchain.

12. The method of claim 1 wherein the platform node operates based on a governance state recorded on-chain, the governance state derived from token-weighted voting and defining at least one of: listing eligibility rules, fee parameters, dispute handling rules, or agent execution permissions.

13. A data provider system for sharing a candidate dataset, comprising:
a memory of a data provider node; and
a processor of the data provider node in communication with the memory, the processor configured to:
receive the candidate dataset and metadata associated with the candidate dataset;
send to an off-chain storage node, the dataset secured at the off-chain storage node based on an access identifier for the off-chain storage node;
generate a listing identifier and an integrity reference linking the metadata to the dataset in the off-chain storage node;
send to a platform node, a dataset listing request comprising the listing identifier, the metadata and the integrity reference linking the metadata to the dataset in the off-chain storage node; and
receive based on the dataset listing request, a dataset listing response comprising a confirmation from the platform node that the dataset has been registered and stored,
wherein when the processor receives a recorded purchase state associated with the listing identifier from a smart contract, emitting to a buyer wallet address an access-key payload comprising the access identifier that is usable by a consumer node associated with the buyer wallet address to access the dataset at the off-chain storage node.

14. The system of claim 13 wherein the dataset listing request further comprises the metadata, the integrity reference to the location of the dataset at the off-chain storage node, wherein the metadata used by the platform node to generate a dataset quality score for comparative ranking and pricing of the dataset without revealing an identity of the data provider node, the data consumer node, and the platform node.

15. The system of claim 14, wherein the processor is further configured to:
determine classification metadata for the candidate dataset;
determine coverage metadata for the candidate dataset;
determine timestamp density metadata of the candidate dataset;
determine commercial metadata for the candidate dataset; and
determine field consistency metadata of the candidate dataset based on a predetermined plurality of fields,
wherein the metadata comprises the classification metadata, the coverage metadata, the timestamp density metadata, the commercial metadata and the field consistency metadata, and
wherein the dataset listing request further comprises an ephemeral copy of the dataset, and the platform node generates the dataset quality score based on the ephemeral copy of the dataset.

16. The system of claim 13 wherein the generating of the dataset, sending the dataset, and the sending the dataset listing request are performed by a provider agentic system at the data provider node.

17. The system of claim 16, wherein the provider agentic system negotiates with a consumer agentic system to thereby perform at least one selected from the group of: generate the recorded purchase state, request clarification metadata, and propose modified commercial parameters subject to at least one constraint defined by organizational policy or governance state.

18. The system of claim 17 wherein the dataset listing request is received by a platform agentic system at the platform node.

19. The system of claim 13, wherein, prior to emitting the access-key payload, the smart contract enforces an escrow challenge window and, upon detection of a dispute event recorded on-chain during the challenge window, withholds or replaces the access-key payload until a resolution state is recorded by at least one selected from the group of: the smart contract and the platform node.

20. The system of claim 13, wherein the processor binds the access-key payload to a license tier stored in either on- or off-chain state for the listing identifier, the license tier defining at least one of: permitted use categories, access duration, or volume limits, and wherein the access-key payload is rendered invalid if a license violation state is recorded.

21. The system of claim 13 wherein the candidate dataset is a streaming candidate dataset.

22. The system of claim 21 wherein the processor rotates a stream access key by emitting successive access-key payloads upon recording periodic usage or settlement states from the smart contract for the listing identifier, thereby enabling access to time-segmented portions of the streaming candidate dataset.

23. The system of claim 13, wherein the processor is further configured to:
monitor on-chain state recorded by the smart contract; and
responsive to a detected purchase completion state, generate and transmit the access-key payload for off-chain dataset retrieval,
wherein the monitoring and transmission are performed off-chain by the platform node processor without execution of application logic on the blockchain.

24. The system of claim 13 wherein the platform node operates based on a governance state recorded on-chain, the governance state derived from token-weighted voting and defining at least one of: listing eligibility rules, fee parameters, dispute handling rules, or agent execution permissions.
